(19) United States
(12) Patent Application Publication
(10) Pub. No.: US 2023/0299891 A1
(43) Pub. Date: Sep. 21, 2023

(54) TRANSMISSION OF DROPPED HARQ-ACK CODEBOOKS DUE TO PRIORITIZATION WITH A TYPE-2 CODEBOOK

(71) Applicant: TELEFONAKTIEBOLAGET LM ERICSSON (PUBL), STOCKHOLM (SE)

(72) Inventors: Kittipong Kittichokechai, JÄRFÄLLA (SE); Bikramjit Singh, RAASEPORI (FI); Zhenhua Zou, SOLNA (SE); Sorour Falahati, STOCKHOLM (SE); Reem Karaki, AACHEN (DE); Yufei Blankenship, KILDEER, IL (US); Mattias Andersson, SUNDBYBERG (SE)

(21) Appl. No.: 18/018,821

(22) PCT Filed: Jul. 29, 2021
(86) PCT No.: PCT/IB2021/056944

§ 371 Date: Jan. 30, 2023

Related U.S. Application Data
(60) Provisional application No. 63/058,335, filed on Jul. 29, 2020.

(51) Int. Cl. H04L 1/1829; H04L 1/1812; H04L 1/1867

(52) U.S. Cl. CPC H04L 1/1854; H04L 1/1812; H04L 1/1887

(57) ABSTRACT

Systems and methods of the present disclosure are directed to a method performed by a wireless communication device for providing Hybrid Automatic Repeat Request (HARQ) feedback. The method includes dropping a first transmission that was to comprise a HARQ-Acknowledgement (HARQ-ACK) codebook that comprises HARQ-ACK feedback information for one or more first Physical Downlink Shared Channel (PDSCH) transmissions. The method includes transmitting a second transmission in which at least a portion of the dropped HARQ-ACK codebook is combined with other HARQ-ACK feedback information for one or more second PDSCH transmissions.

### RELATED APPLICATIONS

This application claims the benefit of United State Provisional Patent App. No. 63/058,335, filed Jul. 29, 2020, the disclosure of which is hereby incorporated herein by reference in its entirety.

### TECHNICAL FIELD

Generally, the present disclosure relates to transmission of dropped Hybrid Automatic Repeat ReQuest Acknowledgement (HARQ-ACK) codebooks.

### BACKGROUND

New Radio (NR) Services

New Radio (NR) standard in Third Generation Partnership Project (3GPP) is designed to provide service for multiple use cases such as enhanced Mobile Broadband (eMBB), Ultra-Reliable and Low Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot is a concept that is used in scheduling. According to current specifications, a min-slot can consist of 2, 4, or 7 Orthogonal Frequency Division Multiplexing (OFDM) symbols in the downlink (DL), while a mini-slot can be any number of 1 to 14 OFDM symbols in the uplink (UL). It should be noted that the concepts of slot and mini-slot are not specific to a specific service meaning that a mini-slot may be used for either eMBB, URLLC, or other services. For example, FIG. 1 illustrates an exemplary radio resource in NR.

Downlink Control Information

In 3GPP NR standard, Downlink Control Information (DCI), which is transmitted in Physical Downlink Control Channel (PDCCH), is used to indicate the DL data related information, UL related information, power control information, slot format indication, etc. There are different formats of DCI associated with each of these control signals and the UE identifies them based on different Radio Network Temporary Identifiers (RNTIs).

A User Equipment (UE) is configured by higher layer signaling to monitor for DCIs in different resources with different periodicities, etc. DCI formats 1_0, 1_1, and 1_2 are used for scheduling DL data which is sent in Physical Downlink Shard Channel (PDSCH). These DCI formats include information that indicates the time and frequency resources for DL transmission, modulation and coding information, HARQ (hybrid automatic repeat request) information, etc.

In case of DL semi-persistent scheduling (SPS) and UL configured grant type 2, part of the scheduling including the periodicity is provided by the higher layer configurations, while the rest of scheduling information such as time domain and frequency domain resource allocation, modulation and coding, etc. are provided by the DCI in PDCCH.

Uplink Control Information

Uplink Control Information (UCI) is control information sent by a UE to a NR base station (gNB). UCI consists of:
Hybrid-ARQ Acknowledgement (HARQ-ACK), which is a feedback information corresponding to the received downlink transport block that indicates whether the transport block reception is successful or not,
Channel State Information (CSI) related to downlink channel conditions which provides the gNB with channel-related information useful for DL scheduling, including information for multi-antenna and beamforming schemes, and
Scheduling Request (SR) which indicates a need of UL resources for UL data transmission.

UCI is typically transmitted on Physical Uplink Control Channel (PUCCH). However, if a UE is transmitting data on the Physical Uplink Shared Channel (PUSCH) with a valid PUSCH resource overlapping with PUCCH, UCI can be multiplexed with UL data and transmitted on PUSCH instead, if the timeline requirements for UCI multiplexing are met.

Physical Uplink Control Channel (PUCCH)

PUCCH is used by a UE to transmit HARQ-ACK feedback message corresponding to the reception of DL data transmission. It is also used by the UE to send CSI or to request for an UL grant for transmitting UL data.

In NR, there exist multiple PUCCH formats supporting different UCI payload sizes. PUCCH formats 0 and 1 support UCI up to 2 bits, while PUCCH formats 2, 3, and 4 can support UCI of more than 2 bits. In terms of PUCCH transmission duration, PUCCH formats 0 and 2 are considered short PUCCH formats supporting PUCCH duration of 1 or 2 OFDM symbols, while PUCCH formats 1, 3, and 4 are considered as long formats and can support PUCCH duration from 4 to 14 symbols.

HARQ Feedback Generation and Transmission

The procedure for receiving downlink transmission is that the UE first monitors and decodes a PDCCH in slot n which points to a DL data scheduled in slot n+K₀ slots (K₀ is larger than or equal to 0). The UE then decodes the data in the corresponding PDSCH. Finally based on the outcome of the decoding, the UE sends an acknowledgement of the correct decoding (ACK) or a negative acknowledgement (NACK) to the gNB at time slot n+K₀+K₁ (in case of slot aggregation n+K₀ would be replaced by the slot where PDSCH ends). Both of K₀ and K₁ are indicated in the DCI. The resources for sending the acknowledgement are indicated by PUCCH resource indicator (PRI) field in the DCI which points to one of the PUCCH resources that are configured by higher layers.

Depending on DL/UL slot configurations, or whether carrier aggregation or per Code-Block Group (CBG) transmission is used in the DL, the feedback for several PDSCHs may need to be multiplexed in one feedback. This is done by constructing HARQ-ACK codebooks. In NR Rel-15, the UE can be configured to multiplex the A/N bits using a semi-static codebook or a dynamic codebook. One-shot and enhanced dynamic HARQ codebooks are introduced in Rel-16 NR.

FIG. 2 illustrates the timeline in a simple scenario with two PDSCHs and one HARQ feedback. In this example, there is in total 4 PUCCH resources configured, and the PUCCH Resource Indicator (PRI) indicates PUCCH 2 to be used for HARQ feedback. We explain in the following how PUCCH 2 is selected from 4 PUCCH resources based on the procedure in Rel-15.

In NR Rel-15, a UE can be configured with a maximum of 4 PUCCH resource sets for transmission of HARQ-ACK information. Each PUCCH resource set is associated with a range of UCI payload bits including HARQ-ACK bits. The first set is always associated to 1 or 2 HARQ-ACK bits and hence includes only PUCCH format 0 or 1 or both. The range of payload values (minimum of maximum values) for other sets, if configured, is provided by configuration except the maximum value for the last set where a default value is used, and the minimum value of the second set being 3. The first set can include maximum 32 PUCCH resources of PUCCH format 0 or 1. Other sets can include maximum 8 bits of PUCCH format 2 or 3 or 4.

As described previously, the UE determines a slot for transmission of HARQ-ACK bits in a PUCCH corresponding to PDSCHs scheduled or activated by DCI via the K1 value provided by configuration or a field in the corresponding DCI. The UE forms a codebook from the HARQ-ACK bits with associated PUCCH in a same slot via corresponding K1 values.

The UE determines a PUCCH resource set that the size of the codebook is within the corresponding range of payload values associated to that set.

The UE determines a PUCCH resource in that set, if the set is configured with maximum 8 PUCCH resources, by a field in the last DCI associated to the corresponding PDSCHs. If the set is the first set and is configured with more than 8 resources, a PUCCH resource in that set is determined by a field in the last DCI associated to the corresponding PDSCHs and implicit rules based on the Control Channel Element (CCE).

A PUCCH resource for HARQ-ACK transmission can overlap in time with other PUCCH resources for CSI and/or SR transmissions as well as PUSCH transmissions in a slot. In case of overlapping PUCCH and/or PUSCH resources, first the UE resolves overlapping between PUCCH resources, if any, by determining a PUCCH resource carrying the total UCI (including HARQ-ACK bits) such that the UCI multiplexing timeline requirements are met. There might be partial or completely dropping of CSI bits, if any, to multiplex the UCI in the determined PUCCH resource. Then, the UE resolves overlapping between PUCCH and PUSCH resources, if any, by multiplexing the UCI on the PUSCH resource if the timeline requirements for UCI multiplexing are met.

Semi-Static (Type-1) HARQ Codebook

Type 1 or semi-static codebook consists of a bit sequence where each element contains the A/N bit from a possible allocation in a certain slot, carrier, or Transport Block (TB). When the UE is configured with CBG and/or time-domain resource allocation (TDRA) table with multiple entries, multiple bits are generated per slot and TB (see below). It is important to note that the codebook is derived regardless of the actual PDSCH scheduling. The size and format of the semi-static codebook is preconfigured based on the mentioned parameters. The drawback of semi-static HARQ ACK codebook is that the size is fixed, and, regardless of whether there is a transmission or not, a bit is reserved in the feedback matrix.

In the case when a UE has a TDRA table with multiple time-domain resource allocation entries configured, the table is pruned (i.e., entries are removed based on a specified algorithm) to derive a TDRA table that only contains non-overlapping time-domain allocations. One bit is then reserved in the HARQ CB for each non-overlapping entry (assuming a UE is capable of supporting reception of multiple PDSCH in a slot).

Dynamic (Type-2) HARQ Codebook

In type 2 or dynamic HARQ codebook, an A/N bit is present in a codebook only if there is a corresponding transmission scheduled. To avoid any confusion between the gNB and the UE on the number of PDSCHs that the UE has to send a feedback for, a counter Downlink Assignment Indicator (DAI) field exists in the DL assignment. The counter DAI denotes accumulative number of {serving cell, PDCCH occasion} pairs in which a PDSCH is scheduled to a UE up to the current PDCCH. In addition to that, there is another field called total DAI, which when present shows the total number of {serving cell, PDCCH occasion} up to (and including) all PDCCHs of the current PDCCH monitoring occasion. The timing for sending HARQ feedback is determined based on both PDSCH transmission slot with reference to PDCCH slot (K₀) and the PUCCH slot that contains HARQ feedback (K₁).

Enhanced Dynamic (Type-2) HARQ Codebook

In Rel-16, enhanced dynamic codebook or enhanced Type-2 codebook based on Type 2 codebook is introduced to enable retransmission of the HARQ feedback corresponding to the used HARQ processes. If, for any reason, the scheduled codebook was not received, the retransmission of the feedback can be requested by the gNB. A toggle bit, New Feedback Indicator (NFI), is added in the DCI to indicate whether the HARQ-ACK feedback from the UE was received by the gNB or not. If toggled (as in FIG. 3), the UE assumes that the reported feedback was correctly received. Otherwise, if the gNB fails to receive the scheduled PUCCH (FIG. 4), the UE is expected to retransmit the feedback. In the latter case, the DAI (C/T-DAI) is not reset, instead the DAI is accumulated within a PDSCH group until NFI for the PDSCH group is toggled. Note that, with respect to the example of FIG. 4, 2-bits DAI is assumed. Hence the actual DAI for the last scheduled PDSCH is 5 but shown as 1=5 mod 2.

As the triggering of additional HARQ feedback reporting occurs with ambiguous timing relation to the associated PDSCHs, PDSCH grouping is introduced. A PDSCH group is defined as the PDSCH(s) for which the HARQ-ACK information is originally indicated to be carried in a same PUCCH. PDSCH grouping allows the gNB to explicitly indicate which exact codebook is missing. The group index is explicitly signaled in the scheduling DCI. If enhanced dynamic codebook is configured, two PDSCH groups are supported. Together with the group Identifier (ID), the gNB signals a request group ID which is a 1-bit field. If set to 0, the gNB is requesting feedback for the scheduled group, otherwise, for both the group scheduling using the DCI and the other one. By referring to the group Id (ID), request ID (RI), and the value of the NFI field in the DCI, the UE can figure out if the next feedback occasion should include only initial transmission or also retransmission of feedback corresponding to PDSCH(s) associated with the indicated group. An example is shown in FIG. 5.

Similar to NR, the DAI value is also included in the UL grant scheduling PUSCH. As an additional functionality, the gNB can indicate the DAI value for each group separately in the UL grant to resolve any possible ambiguity at the UE side.

One-Shot (Type-3) HARQ Codebook

The UE can be configured to monitor feedback request of a HARQ-ACK codebook containing all DL HARQ processes. The feedback can be requested in DL DCI 1_1. In response to the trigger, the UE reports the HARQ ACK feedback for all DL HARQ processes. The format of the feedback, CBG-based HARQ-ACK or TB-based HARQ-ACK, can be configured to be part of the one-shot HARQ feedback for the Component Carriers (CCs) configured with CBG.

Additionally, to resolve any possible ambiguity between the gNB and the UE that might be caused by possible mis-detection of PDCCH(s), the UE can be configured to report the corresponding latest NDI value for a latest received PDSCH for that HARQ process along with the corresponding HARQ-ACK for the received PDSCH. From gNB perspective, if the NDI value matches the last transmitted value, it indicates that the reported HARQ-ACK feedback correctly corresponds to the HARQ process with pending feedback. Otherwise, the mismatch suggests that the UE is reporting an outdated feedback.

PUCCH Repetition Procedure

NR supports PUCCH repetition over multiple slots. This is useful e.g. for increased coverage. Only long PUCCH formats, namely formats 1, 3, and 4 are supported. Number of repetitions (2, 4, or 8 slots) is semi-statically configured by a higher layer parameter nrofSlots in PUCCH-FormatConfig in the PUCCH-config 1E (see FIG. 6, which illustrates the RRC parameter for indicating PUCCH repetition across multiple slots). The same resource allocation (e.g., same number of consecutive symbols, same starting symbol) is used for each repetition over multiple slots. See Section 9.2.6 in TS 38.213 for the complete description.

The semi-static configuration of the number of PUCCH repetitions by nrofSlots in PUCCH-FormatConfig is done per PUCCH format separately. Once it is configured, it is applied to all PUCCH resources of that particular format.

Sub-Slot HARQ-ACK

In NR Rel-16, an enhancement on HARQ-ACK feedback is made to support more than one PUCCH carrying HARQ-ACK in a slot for supporting different services and for possible fast HARQ-ACK feedback for URLLC. This leads to an introduction of new HARQ-ACK timing in a unit of sub-slot, i.e., K₁ indication in a unit of sub-slot. Sub-slot configurations for PUCCH carrying HARQ-ACK can be configured from the two options, namely “2-symbol*7” and “7-symbol*2” for the sub-slot length of 2 symbols and 7 symbols, respectively. The indication of K₁ is the same as that of Rel-15, that is, K₁ is indicated in the DCI scheduling PDSCH. To determine the HARQ-ACK timing, there exists an association of PDSCH to sub-slot configuration in that, if the scheduled PDSCH ends in sub-slot n, the corresponding HARQ-ACK is reported in sub-slot n+Kl. In a sense, sub-slot based HARQ-ACK timing works similarly to that of Rd-15 slot-based procedure by replacing the unit of K₁ from slot to sub-slot.

There exist some limitations on PUCCH resources for sub-slot HARQ-ACK. That is, only one PUCCH resource configuration is used for all sub-slots in a slot. Moreover, any PUCCH resource for sub-slot HARQ-ACK cannot cross sub-slot boundaries.

FIG. 7 shows an example where each PDSCH is associated with a certain sub-slot for HARQ feedback through the use of a K1 value in units of sub-slots. In particular, Figure X7 illustrates an example of K₁ indication based on subs-slots with “7-symbol*2” configuration for 2 PUCCHs in two sub-slots that carry the HARQ feedback of PDSCH transmissions.

Priority Indication of HARQ-ACK

In Rel-16, two-level PHY priority can be indicated in the DCI for HARQ-ACK corresponding to a dynamically scheduled PDSCH or RRC-configured for HARQ-ACK corresponding to DL SPS. This priority indication can be used to determine the priority of the HARQ-ACK codebook for collision handling. NR Rel-16 supports up to two HARQ-ACK codebooks with different priorities to be simultaneously constructed. This includes one being slot-based and one being sub-slot-based, both being slot-based, or both being sub-slot-based.

Non-numerical K1 values

As an enhancement to rel-15, the gNB can signal a non-numerical value in the PDSCH-to-HARQ-timing-indicator field in the DCI. When signaled, it indicates that the UE should hold on the HARQ-ACK feedback for the corresponding PDSCH until the timing and resource for the HARQ-ACK feedback is provided by the gNB in another DCI. The HARQ-ACK timing for PDSCH scheduled with non-numerical value for K₁ is derived by the next DCI scheduling a PDSCH and indicating a numerical value in the PDSCH-to-HARQ-timing-indicator.

### SUMMARY

One embodiment of the present disclosure is directed to a method performed by a wireless communication device for providing Hybrid Automatic Repeat Request (HARQ) feedback. The method includes dropping a first transmission that was to comprise a HARQ-Acknowledgement (HARQ-ACK) codebook that comprises HARQ-ACK feedback information for one or more first Physical Downlink Shared Channel (PDSCH) transmissions. The method includes transmitting a second transmission in which at least a portion of the dropped HARQ-ACK codebook is combined with other HARQ-ACK feedback information for one or more second PDSCH transmissions.

In some embodiments, dropping the first transmission comprises dropping the first transmission due to an overlap with a higher priority transmission within a time domain

In some embodiments, dropping the first transmission comprises dropping the first transmission due to an overlap with a transmission that comprises higher priority HARQ-ACK feedback information within a time domain.

In some embodiments, transmitting the second transmission comprises detecting a Downlink Control Information (DCI) that schedules a PDSCH transmission, the DCI being detected subsequent to a latest DCI from among one or more DCIs that scheduled the one or more first PDSCH transmissions, and transmitting a Physical Uplink Control Channel (PUCCH) or Physical Uplink Shared Channel (PUSCH) transmission that comprises at least a portion of the dropped HARQ-ACK codebook combined with other HARQ-ACK feedback information for the PDSCH transmission scheduled by the DCI.

In some embodiments, detecting the DCI that schedules the PDSCH transmission comprises detecting that the DCI comprises an indication that a UE should include previously dropped HARQ-ACK data in a HARQ-ACK codebook.

In some embodiments, transmitting the second transmission comprises transmitting the at least a portion of the dropped HARQ-ACK codebook in the second transmission as if each K1 value associated to each bit in the dropped HARQ-ACK codebook is a non-numerical value, irrespective of actual K1 values associated to the bits in the dropped HARQ-ACK codebook.

In some embodiments, transmitting the second transmission comprises including the at least a portion of the dropped HARQ-ACK codebook in the second transmission responsive to a counter Downlink Assignment Indicator (DAI) based determination.

In some embodiments, the second transmission is an immediate next PUCCH, or PUSCH transmission that comprises HARQ-ACK feedback information (e.g., low priority HARQ-ACK feedback information).

In some embodiments, the second transmission is an earliest PUCCH, or PUSCH, transmission that comprises HARQ-ACK feedback information (e.g., low priority HARQ-ACK feedback information) following a certain required time gap.

In some embodiments, the second transmission in which the dropped HARQ-ACK codebook is to be included is explicitly indicated to the wireless communication device (812) (e.g., from an associated base station).

In some embodiments, the second transmission is a transmission due to which the first transmission was dropped (e.g., a higher priority transmission).

In some embodiments, the second transmission corresponds to a PUCCH with a priority higher than a priority of the first transmission, and the first transmission is dropped based at least in part on the priority of the PUCCH and the priority of the first transmission.

In some embodiments, the second transmission is determined based on PDSCH grouping in an enhanced dynamic codebook.

Another embodiment of the present disclosure is directed to a wireless communication device for providing HARQ feedback. The wireless communication device is adapted to drop a first transmission that was to comprise a HARQ-ACK codebook that comprises HARQ-ACK feedback information for one or more first PDSCH transmissions. The wireless communication device is adapted to transmit a second transmission in which at least a portion of the dropped HARQ-ACK codebook is combined with other HARQ-ACK feedback information for one or more second PDSCH transmissions.

Another embodiment of the present disclosure is directed to a wireless communication device for providing HARQ feedback. The wireless communication device comprises one or more transmitters. The wireless communication device comprises one or more receivers. The wireless communication device comprises processing circuitry associated with the one or more transmitters and the one or more receivers. The processing circuitry is configured to cause the wireless communication device to drop a first transmission that was to comprise a HARQ-ACK codebook that comprises HARQ-ACK feedback information for one or more first

PDSCH transmissions. The processing circuitry is configured to cause the wireless communication device to transmit a second transmission in which at least a portion of the dropped HARQ-ACK codebook is combined with other HARQ-ACK feedback information for one or more second PDSCH transmissions.

Another embodiment of the present disclosure is directed to a method performed by a base station for obtaining HARQ feedback. The method includes receiving, from a wireless communication device, a transmission in which at least a portion of a dropped HARQ-ACK codebook for one or more first PDSCH transmissions is combined with other HARQ-ACK feedback information for one or more second PDSCH transmissions.

In some embodiments, the dropped HARQ-ACK codebook was dropped due to overlap with a higher priority transmission within a time domain

In some embodiments, receiving the transmission comprises receiving the at least a portion of the dropped HARQ-ACK codebook in the transmission as if each K1 value associated to each bit in the dropped HARQ-ACK codebook is a non-numerical value, irrespective of actual K1 values associated to the bits in the dropped HARQ-ACK codebook.

In some embodiments, the method further includes transmitting a DCI that schedules a PDSCH transmission, the DCI being subsequent to a latest DCI from among one or more DCIs that scheduled the one or more first PDSCH transmissions. In some embodiments, receiving the transmission comprises receiving a PUCCH, or PUSCH, transmission that comprises at least a portion of the dropped HARQ-ACK codebook combined with other HARQ-ACK feedback information for the PDSCH transmission scheduled by the DCI.

In some embodiments, the transmission is an immediate next PUCCH, or PUSCH, transmission that comprises HARQ-ACK feedback information (e.g., low priority HARQ-ACK feedback information) following the dropping of the HARQ-ACK codebook.

In some embodiments, the transmission is an earliest PUCCH, or PUSCH, transmission that comprises HARQ-ACK feedback information (e.g., low priority HARQ-ACK feedback information) following a certain required time gap after the HARQ-ACK codebook was dropped.

In some embodiments, the method further comprises providing, to the wireless communication device, an explicit indication of the transmission in which the dropped HARQ-ACK codebook is to be included.

In some embodiments, the transmission is a transmission due to which the dropped HARQ-ACK codebook was dropped (e.g., a higher priority transmission).

In some embodiments, the transmission is determined based on one or more rules.

In some embodiments, the transmission is determined based on PDSCH grouping in enhanced dynamic codebook.

Another embodiment of the present disclosure is directed to a base station for obtaining HARQ feedback. The base station is adapted to receive, from a wireless communication device, a transmission in which at least a portion of a dropped HARQ-ACK codebook for one or more first PDSCH transmissions is combined with other HARQ-ACK feedback information for one or more second PDSCH transmissions.

Another embodiment of the present disclosure is directed to a base station for obtaining HARQ feedback. The base station comprises processing circuitry configured to cause the base station to receive, from a wireless communication device, a transmission in which at least a portion of a dropped HARQ-ACK codebook for one or more first PDSCH transmissions is combined with other HARQ-ACK feedback information for one or more second PDSCH transmissions.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary radio resource in New Radio (NR);

FIG. 2 illustrates the timeline in a simple scenario with two Physical Downlink Shared Channels (PDSCHs) and one Hybrid Automatic Repeat reQuest (HARQ) feedback;

FIG. 3 illustrates a toggled toggle bit added to Downlink Control Information (DCI) to indicate whether HARQ-acknowledgement (HARQ-ACK) feedback from a User Equipment (UE) was received by a New Radio Base Station (gNB) or not;

FIG. 4 illustrates an example scenario in which a gNB fails to receive a scheduled Physical Uplink Control channel (PUCCH);

FIG. 5 illustrates an example scenario in which a UE determines if a next feedback occasion should include only initial transmission or also retransmission of feedback corresponding to PDSCH(s) associated with the indicated group by referring to the group Id (ID), request ID (RI), and the value of the New Feedback Indicator (NFI) field in the DCI;

FIG. 6 illustrates a Radio Resource Control (RRC) parameter for indicating PUCCH repetition across multiple slots;

FIG. 7 shows an example where each PDSCH is associated with a certain sub-slot for HARQ feedback through the use of a K1 value in units of sub-slots;

FIG. 8 illustrates one example of a cellular communications system in which embodiments of the present disclosure may be implemented;

FIG. 9 is a flow chart that illustrates the operation of a UE in accordance with at least some of the embodiments described in the section of the present disclosure titled “Methods for transmission of dropped low priority CodeBook (CB) based on non-numerical K₁”;

FIG. 10 is a flow chart that illustrates the operation of a User Equipment (UE) in accordance with at least some of the embodiments described in the section of the present disclosure titled “Methods for transmission of dropped low priority HARQ-ACK CB based on Downlink Assignment Indicator (DAI) determination”;

FIG. 11 illustrates an example of transmission of dropped CB in next PUCCH based on DAI determination;

FIG. 12 illustrates a scenario in which 5 low priority PDSCHs are transmitted, however, the 1st low priority PUCCH corresponding to first two PDSCHs is cancelled due to some reasons;

FIG. 13 illustrates an example of transmission of dropped codebook in next PUCCH;

FIG. 14 is a flow chart that illustrates the operation of a UE in accordance with at least some of the embodiments described in the section of the present disclosure titled “Methods for transmission of dropped low priority CB without explicit indication”;

FIG. 15 illustrates an example of transmission of dropped CB in next PUCCH based on explicit indication;

FIG. 16 is a flow chart that illustrates the operation of a UE in accordance with at least some of the embodiments described in the section of the present disclosure titled “Methods for transmission of dropped low priority CB based on explicit indications”;

FIG. 17 is a flow chart that illustrates the operation of a UE 812 in accordance with at least some of the embodiments described in the section of the present disclosure titled “Methods for transmission of dropped low priority HARQ-ACK based on an implicit rule”;

FIG. 18 is a schematic block diagram of a radio access node according to some embodiments of the present disclosure;

FIG. 19 is a schematic block diagram that illustrates a virtualized embodiment of the radio access node 1800 according to some embodiments of the present disclosure;

FIG. 20 is a schematic block diagram of the radio access node 1800 according to some other embodiments of the present disclosure;

FIG. 21 is a schematic block diagram of a wireless communication device 2100 (e.g., a UE such as the UE 812) according to some embodiments of the present disclosure;

FIG. 22 is a schematic block diagram of the wireless communication device 2100 according to some other embodiments of the present disclosure;

FIG. 23 is a communication system that includes a telecommunication network 2300, such as a Third Generation Partnership Project (3GPP)-type cellular network, which comprises an access network 2302, such as a Radio Access Network (RAN), and a core network 2304 according to some embodiments of the present disclosure;

FIG. 24 illustrates example implementations of a UE, base station, and host computer according to some embodiments of the present disclosure;

FIG. 25 is a flowchart illustrating a method implemented in a communication system, in accordance with one embodiment;

FIG. 26 is a flowchart illustrating a method implemented in a communication system, in accordance with one embodiment;

FIG. 27 is a flowchart illustrating a method implemented in a communication system, in accordance with one embodiment;

FIG. 28 is a flowchart illustrating a method implemented in a communication system, in accordance with one embodiment; and

FIG. 29 is a flowchart illustrating a method performed by a base station for obtaining HARQ feedback.

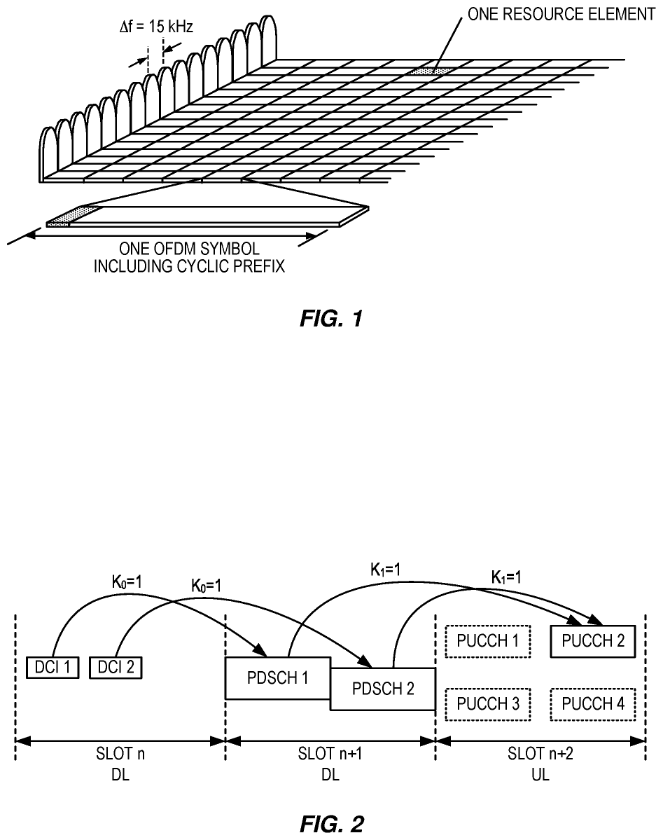

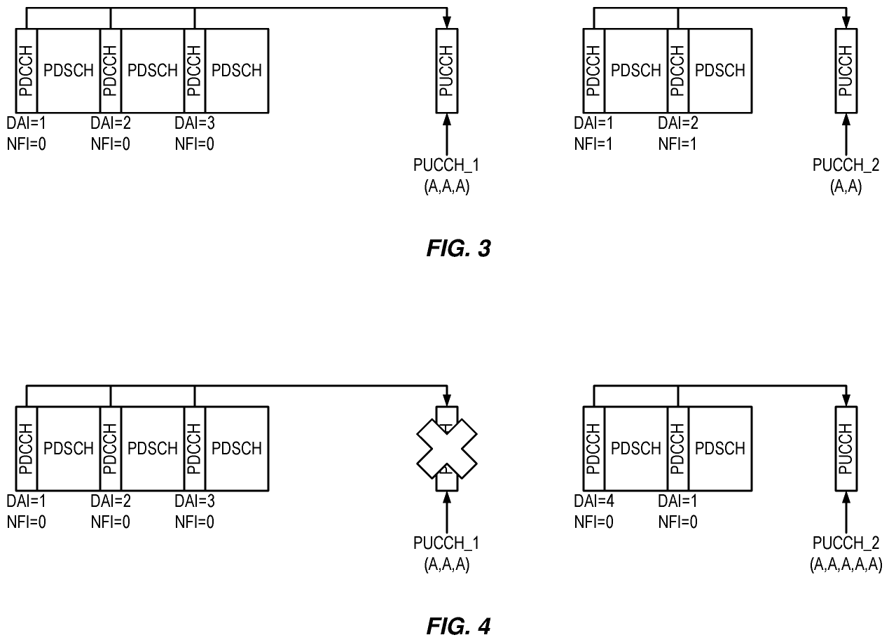

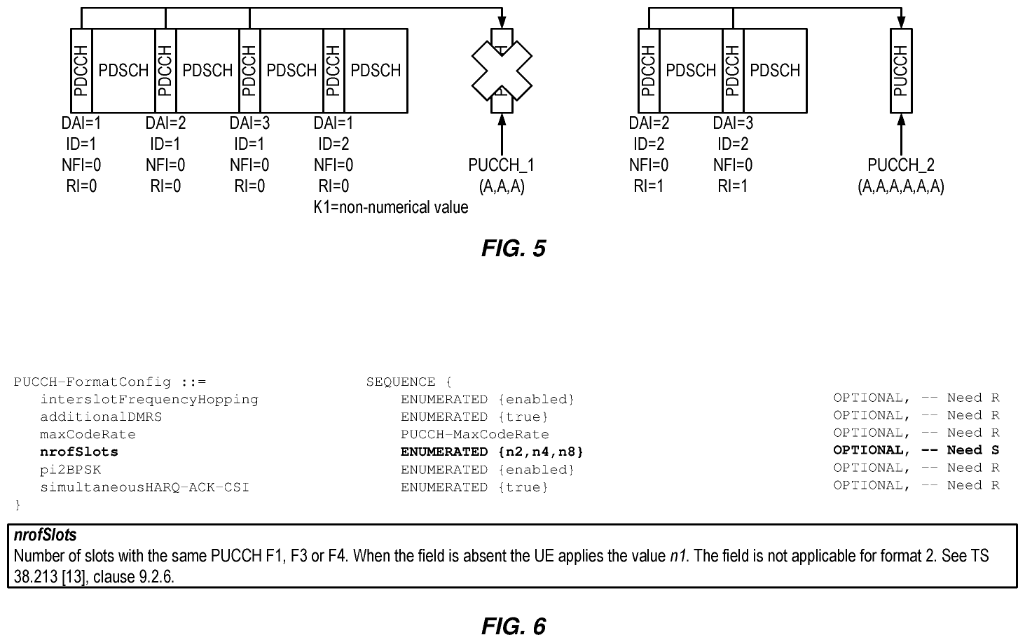

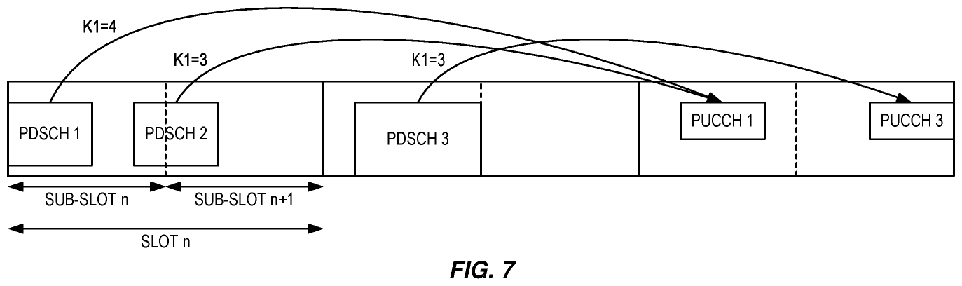

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an

Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In Rel-16, a transmission at physical layer can be associated to low or high priorities. When Physical Uplink Control Channel (PUCCH)/Physical Uplink Shared Channel (PUSCH) transmissions of different priorities are overlapped in time, first overlapping is resolved between transmissions of the same priority following Rel-15 procedures. Then overlapping is resolved between transmissions with different priorities, if any. The resolution is based on prioritization where, among the overlapping resources, the high priority transmission is transmitted and the low priority one is dropped or canceled.

In case the low priority transmission is a PUCCH with Hybrid Automatic Repeat reQuest Acknowledgement (HARQ-ACK), dropping such the transmission implies that the gNB would not receive the HARQ-ACK feedback for the corresponding Physical Downlink Shared Channels (PDSCHs). That means, due to the lack of feedback, the gNB may schedule again the previously scheduled PDSCHs. This in turn results in system degradation performance and decreases the throughput especially for those PDSCHs that had been received successfully with the corresponding HARQ-ACK feedback as ACK.

Certain aspects of the present disclosure and their embodiments may provide solutions to the aforementioned or other challenges. When the transmission of HARQ-ACK information in a PUCCH is cancelled due to collision with a high priority transmission, after dropping the HARQ-ACK information, the UE transmits the dropped HARQ-ACK information in another PUCCH transmission. Assuming HARQ-ACK codebook generation is based on dynamic or enhanced dynamic HARQ codebook, the solution(s) discussed here are based on one or more of the following principles:
Assuming non-numerical K₁ for dropped HARQ-ACK with corresponding PDSCHs and reusing Rel-16 behavior for PDSCHs scheduled by Downlink Control Informations (DCIs) with non-numerical K1 values.
Assuming transmission of dropped HARQ-ACK in a next PUCCH when the corresponding Downlink Assignment Indicator (DAI) in DCI corresponding to the PUCCH has increased to account for dropped HARQ Codebook (CB).
Assuming transmission of dropped HARQ-ACK in a next PUCCH when a dropped feedback request is triggered in the DCI corresponding to the PUCCH via a flag in DCI.

Certain embodiments may provide one or more of the following technical advantage(s). Embodiments of the solutions proposed herein enable the transmission of dropped HARQ-ACK which avoids unnecessary transmission by the gNB of already transmitted transport blocks that have been received correctly. This improves the system performance and results in a more efficient resource utilization.

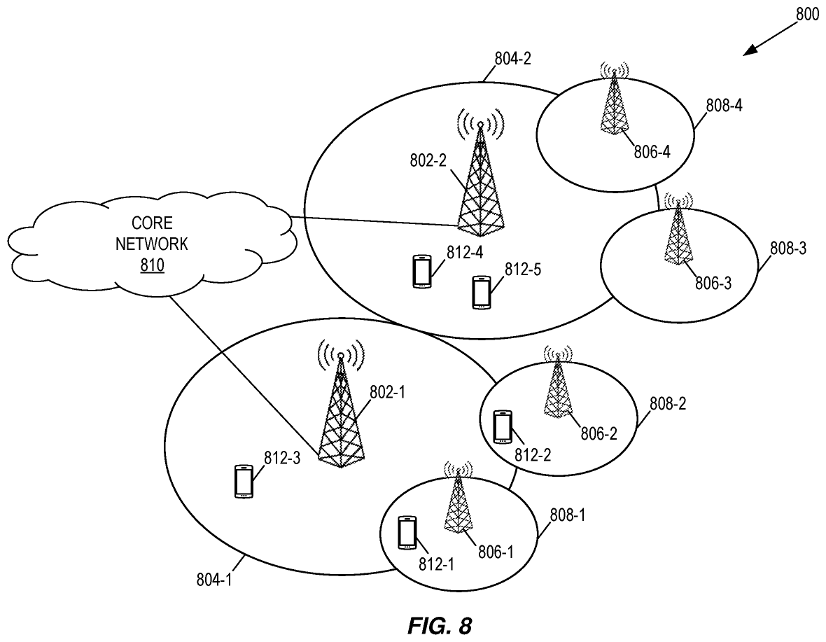

FIG. 8 illustrates one example of a cellular communications system 800 in which embodiments of the present disclosure may be implemented. In the embodiments described herein, the cellular communications system 800 is a 5G system (5GS) including a Next Generation RAN (NG-RAN) and a 5G Core (5GC); however, the embodiments of the present disclosure are not limited thereto. In this example, the RAN includes base stations 802-1 and 802-2, which in the 5GS include NR base stations (gNBs) and optionally next generation eNBs (ng-eNBs) (e.g., LTE RAN nodes connected to the 5GC), controlling corresponding (macro) cells 804-1 and 804-2. The base stations 802-1 and 802-2 are generally referred to herein collectively as base stations 802 and individually as base station 802. Likewise, the (macro) cells 804-1 and 804-2 are generally referred to herein collectively as (macro) cells 804 and individually as (macro) cell 804. The RAN may also include a number of low power nodes 806-1 through 806-4 controlling corresponding small cells 808-1 through 808-4. The low power nodes 806-1 through 806-4 can be small base stations (such as pico or femto base stations) or Remote Radio Heads (RRHs), or the like. Notably, while not illustrated, one or more of the small cells 808-1 through 808-4 may alternatively be provided by the base stations 802. The low power nodes 806-1 through 806-4 are generally referred to herein collectively as low power nodes 806 and individually as low power node 806. Likewise, the small cells 808-1 through 808-4 are generally referred to herein collectively as small cells 808 and individually as small cell 808. The cellular communications system 800 also includes a core network 810, which in the 5G System (5GS) is referred to as the 5GC. The base stations 802 (and optionally the low power nodes 806) are connected to the core network 810.

The base stations 802 and the low power nodes 806 provide service to wireless communication devices 812-1 through 812-5 in the corresponding cells 804 and 808. The wireless communication devices 812-1 through 812-5 are generally referred to herein collectively as wireless communication devices 812 and individually as wireless communication device 812. In the following description, the wireless communication devices 812 are oftentimes UEs, but the present disclosure is not limited thereto.

A description of some particular embodiments of the present disclosure will be provided below. This description does not distinguish transport block (TB)-based HARQ-ACK and Code Block Group (CBG)-based HARQ-ACK. It is understood by those skilled in the art that the same methodologies described in sections below apply to both TB-based HARQ-ACK and CBG-based HARQ-ACK. The same methodology also applies if a HARQ-ACK codebook consists of two sub-codebooks, with a first sub-codebook for aggregated cells without CBG configuration, and a second sub-codebook is used for aggregated cells with CBG configuration.

Transmission of a Dropped HARQ-ACK Codebook due to Collision

When a PUCCH with low priority HARQ-ACK codebook (CB) overlaps with a high priority transmission, for example a high priority PUCCH with HARQ-ACK, the UE cancels (i.e., drops) the PUCCH transmission with low priority HARQ-ACK CB and transmits the high priority transmission. The following embodiments provide methods that can be used individually or in combination for re-transmission of the low priority HARQ-ACK CB corresponding to the dropped PUCCH after the cancellation.

In the following, the term “dropped low priority codebook (CB)” refers to the low priority codebook where its associated PUCCH is dropped due to overlapping with a high priority transmission.

In the discussion below, it is assumed that the priority index has integer values greater than or equal to zero, and larger priority index value implies higher priority designation. For example, in Rel-16, two levels of priority indices, {0, 1}, are provided, where transmission with priority index=1 is treated with higher priority than transmission with priority index=0. While it is possible to have more than two levels of priority indices, for simplicity, the discussion below assumes two levels of priority indices, {0, 1}. It is understood by those skilled in the art that the same design principles can be applied to a system with more than two levels of priority indices.

A. Methods for transmission of dropped low priority CB based on non-numerical K₁

In this embodiment, upon cancellation of the transmission of the low priority HARQ-ACK codebook due to overlapping with the high priority PUCCH, the UE (e.g., UE 812) assumes that the corresponding K1 value for each of the HARQ-ACK bits in the low priority CB is non-numerical irrespective of the previously determined K1 value that had contributed in generation of the low priority CB. In other words, the UE determines a HARQ-ACK CB with non-numerical K1 value.

If the UE detects a later DCI scheduling a PDSCH with a numerical K1 value after the last DCI scheduling a PDSCH with an HARQ-ACK included in the low priority CB, the UE multiplexes the low priority CB with the HARQ-ACK corresponding the PDSCH scheduled by the later DCI, e.g., as specified in Rel-16.

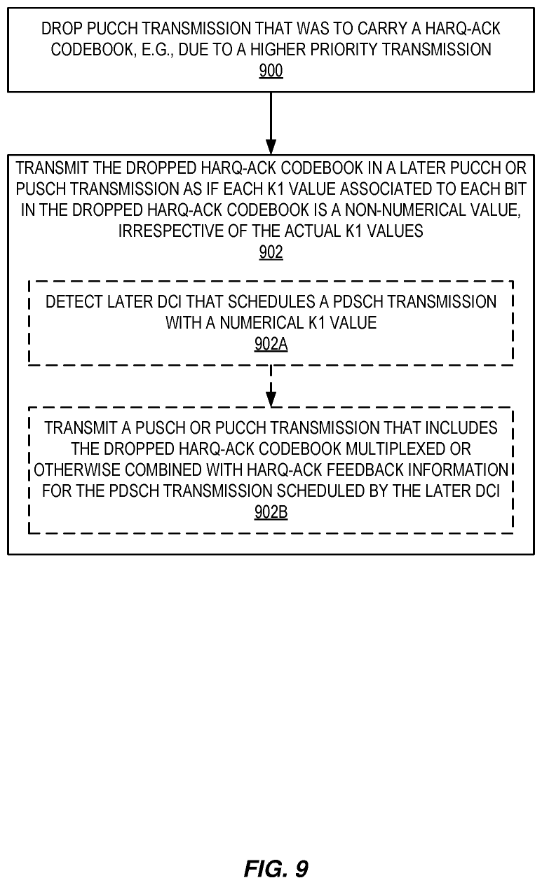

FIG. 9 is a flow chart that illustrates the operation of a UE 812 in accordance with at least some of the embodiments described in this section. As illustrated, the UE 812 drops PUCCH transmission that was to carry a HARQ-ACK codebook comprising HARQ-ACK information for one or more respective PDSCH transmissions (step 900). The HARQ-ACK codebook that was to be carried in the dropped PUCCH transmission is sometimes referred to herein as dropped HARQ-ACK codebook. The PUCCH transmission may be dropped due to, e.g., overlap with a higher priority transmission (e.g., a higher priority PUCCH transmission with HARQ-ACK feedback information). In some embodiments, dropping the first transmission at step 900 includes dropping the first transmission due to a higher priority transmission. Alternatively, in some embodiments, dropping the first transmission includes dropping the first transmission due to a transmission that includes higher priority HARQ-ACK feedback information.

Upon dropping the PUCCH transmission, the UE 812 transmits the dropped HARQ-ACK codebook in a later PUCCH or PUSCH transmission as if an associated K1 value for each bit in the dropped HARQ-ACK codebook is a non-numerical value, irrespectively of the actual K1 values for the bits in the dropped HARQ-ACK codebook (step 902). More specifically, the UE 812 detects a later DCI that schedules a PDSCH with a numerical K1 value (step 902A). The later DCI is a DCI received after a last DCI scheduling a PDSCH having associated HARQ-ACK feedback information (e.g., a HARQ-ACK bit) in the dropped HARQ-ACK codebook. The UE 812 transmits a PUSCH or PUCCH transmission in which the dropped HARQ-ACK codebook is multiplexed or otherwise combined with the HARQ-ACK feedback corresponding to the PDSCH scheduled by the later DCI, as described above (step 902B).

In some embodiments, transmitting the second transmission at step 902 includes including the at least a portion of the dropped HARQ-ACK codebook in the second transmission responsive to a counter DAI based determination. In some embodiments, the second transmission is an immediate next PUCCH or PUSCH transmission that includes HARQ-ACK feedback information (e.g., low priority HARQ-ACK feedback information). Alternatively, in some implementations, the second transmission is an earliest PUCCH or PUSCH transmission that comprises HARQ-ACK feedback information (e.g., low priority HARQ-ACK feedback information) following a certain required time gap. In some embodiments, the second transmission in which the dropped HARQ-ACK codebook is to be included is explicitly indicated to the wireless communication device (e.g., from an associated base station). In some embodiments, the second transmission is a transmission due to which the first transmission was dropped (e.g., a higher priority transmission).

In some embodiments, the second transmission is determined based on one or more rules. Alternatively, or additionally, in some embodiments, the second transmission is determined based on PDSCH grouping in enhanced dynamic codebook.

The UE can be configured with dynamic HARQ-ACK code book or enhanced dynamic HARQ-ACK code book, as in Rel-16. Also, the later DCI can trigger one-shot HARQ similar to that defined in Rel-16 if one-shot HARQ is configured, similarly to rel-16. When the low priority CB is multiplexed with the later dynamic or enhanced dynamic codebook, the multiplexing is done such that the low priority CB is appended or prepended to the new CB.

The following conditions can be considered for the operation:
C1: The later DCI should be a DCI providing a low priority.
C2: The later DCI can be a DCI with low or high priority.

The DCI above can be any of the DCI formats defined for scheduling PDSCH, e.g., 1_0, 1_1, 1_2. For dynamically scheduled PDSCH, it is understood that low priority for HARQ-ACK can be indicated by either (a) a DCI without “priority indicator” field configured, or a DCI with “priority indicator” field configured and taking value “0”. In contrast, high priority for HARQ-ACK is indicated by a DCI with “priority indicator” field configured and taking value “1.”

Operation based on condition Cl or C2 can be based on rules known to the UE. In other words, the later DCI detected in step 902A is a later DCI that is detected by the UE 812 and that satisfies condition either condition Cl or C2, where the condition to be satisfied is, in one embodiment, determined by the UE 812 based on one or more rules. In one example, the rule can be that by default C1 is applicable, or by default C2 is applicable. In another example, the rule can be that the choice between these conditions can be determined by higher layers, for example a Radio Resource Control (RRC) parameter determines whether Cl is enabled or applicable, or C2. In another example, the rule can be signaled dynamically to the UE. This can be done by configuration a flag in DCI. The rule can be that, when the flag is present and triggered, Cl is applicable. Alternatively, the rule can be that, when the flag is triggered, C2 is applicable. In the rules above depending on the RRC parameter or a flag, the UE can assume that the absence of the corresponding RRC parameter or flag corresponds to applicability of one of the Cl or C2.

In another follow-up embodiment, if the UE transmits the PUCCH in response to a Semi-persistent Scheduling (SPS) PDSCH reception or SPS PDSCH release, then the low priority HARQ-ACK CB with non-numerical K₁ is multiplexed by the UE on the indicated PUCCH resource. Each SPS configuration can be associated with two HARQ Codebook IDs (i.e., a value of 1 or 2), in which one corresponds to a high priority and another corresponds to a low priority. A similar PUCCH resource association can be considered. The low priority HARQ-ACK bits with non-numerical K₁ is considered only with the SPS with a given HARQ codebook ID. This can be fixed in the spec and corresponds to the HARQ codebook associated with the lower priority, or configurable by RRC to one of the two HARQ codebook ID, or configurable by RRC to be associated to a HARQ codebook ID.

In another embodiment, the re-attempt of HARQ-ACK transmission can be applied to other scenarios that UE didn't transmit HARQ-ACK bits according to signaled timing. In one example, the HARQ-ACK bits were not transmitted due to not satisfying UE processing time requirements.

In another embodiment, to avoid misunderstanding between gNB and UE caused by misdetection of a Physical Downlink Control Channel (PDCCH), the UE includes the re-attempted HARQ-ACK bits in a codebook signaled by a later DCI (for example, those in C1 and C2) only when the DCI explicitly indicates it. The DCI indication can be via a DCI field, or a combination of two or more DCI field values, or a special Radio Network Temporary Identifier (RNTI). If the DCI does not indicate the inclusion of re-attempted HARQ-ACK bits, then the UE builds the HARQ-ACK codebook without considering the existence of dropped HARQ-ACK bits. Additionally, the UE may save the dropped HARQ-ACK bits till they are overridden by latter HARQ-ACK bits of the same HARQ process.

B. Methods for transmission of dropped low priority HARQ-ACK CB based on DAI determination

In this embodiment, upon cancellation of the transmission of the low priority HARQ-ACK codebook due to overlapping with the high priority PUCCH or PUSCH, the UE (e.g., UE 812) assumes that it is expected to multiplex the low priority CB with the HARQ-ACK to be transmitted in the next earliest PUCCH (or PUSCH) carrying low priority HARQ-ACK. In this case, the UE is expected to multiplex the low priority CB corresponding to the canceled HARQ-ACK with the new low priority CB to form a combined low priority CB for transmission in a PUCCH or PUSCH. The new CB and the CB corresponding to dropped HARQ-ACK bits are concatenated in the combined CB, where the combined CB can start or end with the low priority CB corresponding to cancelled PUCCH or PUSCH.

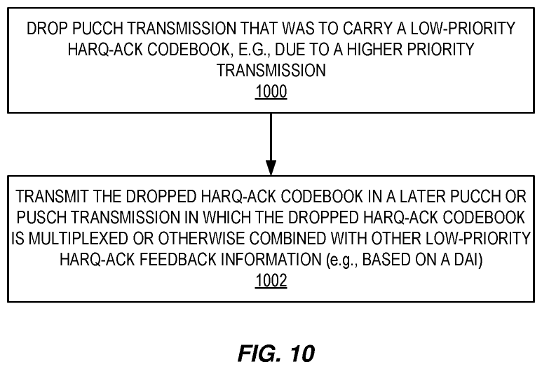

FIG. 10 is a flow chart that illustrates the operation of a UE 812 in accordance with at least some of the embodiments described in this section. As illustrated, the UE 812 drops PUCCH transmission that was to carry a low-priority HARQ-ACK codebook comprising HARQ-ACK information for one or more respective PDSCH transmissions (step 1000). The HARQ-ACK codebook that was to be carried in the dropped PUCCH transmission is sometimes referred to herein as dropped HARQ-ACK codebook. The PUCCH transmission may be dropped due to, e.g., overlap with a higher priority transmission (e.g., a higher priority PUCCH transmission with HARQ-ACK feedback information). In some embodiments, dropping the first transmission at step 1000 includes dropping the first transmission due to a higher priority transmission. Alternatively, in some embodiments, dropping the first transmission at step 1000 includes dropping the first transmission due to a transmission that includes higher priority HARQ-ACK feedback information.

Upon dropping the PUCCH transmission, the UE 812 transmits the dropped low-priority HARQ-ACK codebook in a later PUCCH or PUSCH transmission by multiplexing or otherwise combining the dropped low-priority HARQ-ACK codebook with other low-priority HARQ-ACK feedback information (step 1002).

In some embodiments, transmitting the second transmission at step 1002 includes including the at least a portion of the dropped HARQ-ACK codebook in the second transmission responsive to a counter DAI based determination. In some embodiments, the second transmission is an immediate next PUCCH or PUSCH transmission that includes HARQ-ACK feedback information (e.g., low priority HARQ-ACK feedback information). Alternatively, in some implementations, the second transmission is an earliest PUCCH or PUSCH transmission that comprises HARQ-ACK feedback information (e.g., low priority HARQ-ACK feedback information) following a certain required time gap. In some embodiments, the second transmission in which the dropped HARQ-ACK codebook is to be included is explicitly indicated to the wireless communication device (e.g., from an associated base station). In some embodiments, the second transmission is a transmission due to which the first transmission was dropped (e.g., a higher priority transmission).

In some embodiments, the second transmission is determined based on one or more rules. Alternatively, or additionally, in some embodiments, the second transmission is determined based on PDSCH grouping in enhanced dynamic codebook.

As one aspect of this embodiment, the combined CB is constructed by appending/concatenated two separate CBs, where at least one of the CBs corresponds to the dropped HARQ-ACK bits. As another variant of this embodiment, the combined CB is a single CB where at least one of the reported HARQ-ACK bits corresponds to previously dropped HARQ-ACK bits.

The UE expects that the counter DAI for the new CB continues from the earlier DAI value to account for the low priority CB with canceled PUCCH.

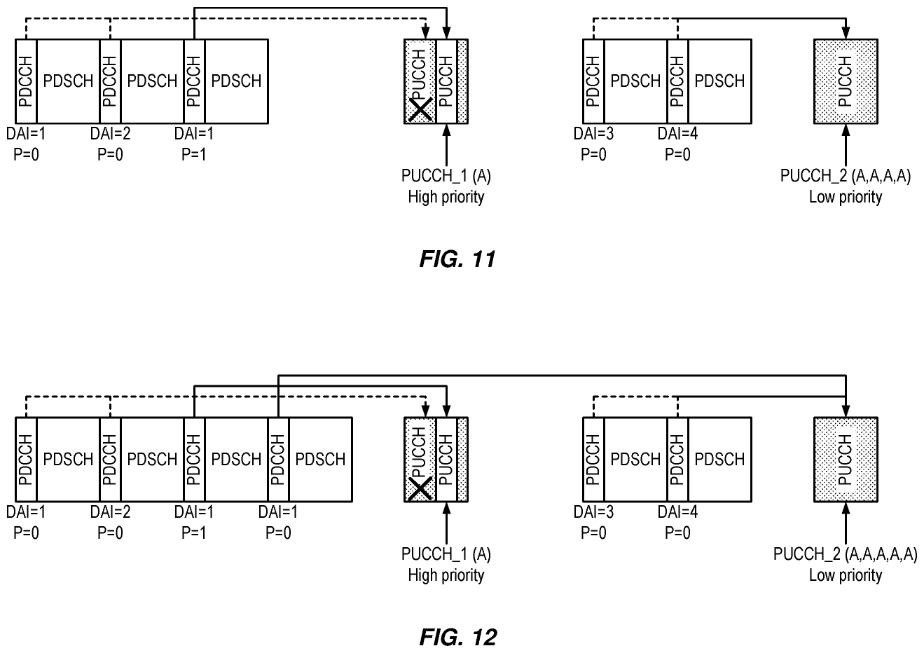

An example of transmission of dropped CB in next PUCCH based on DAI determination is shown in FIG. 11.

If a different counter DAI is indicated from the network, UE interprets that there are missing PDCCHs. Taking FIG. 8 as an example, if DAI is equal to 4 instead of 3 in the 4th PDCCH (from the left), then UE interprets that there is a missing PDCCH reception and, in the codebook, five HARQ-ACK bits are added. In other words, the HARQ-ACK of the low priority CB is to be multiplexed in the next suitable PUCCH resource for the low priority CB.

In another method, network may schedule the re-transmission of the PDSCH (by indicating the same HARQ process) whose low priority CB is dropped. This can happen if there is no subsequent downlink data. In such a case, UE keeps the low priority CB as pending till it is transmitted. If a scheduling DCI indicated for the same HARQ process is received before the pending low priority CB is transmitted, UE considers it as transmitted. In other words, UE does not expect the later counter DAI to continue from the earlier DAI value that includes this low priority CB.

The above procedures can continue until the low priority CB corresponding to the first canceled PUCCH is transmitted. Alternatively, for a given low priority CB with canceled PUCCH, the procedure can continue maximum X times, where either a default value is assumed for X, e.g. X=1, or X is configured by higher layers. In this case, the UE can assume that it is not expected to combine a low priority CB corresponding to a cancelled PUCCH in another low priority CB more than X times. In other words, the UE attempts to combine a low priority CB corresponding to a cancelled PUCCH in a next PUCCH occasion. If it fails (e.g., the PUCCH is dropped again), the UE is not expected to multiplex the HARQ-ACK of the low priority CB that has been twice dropped any further.

In another option, the dropped HARQ-ACKs for dynamic PDSCHs are placed where DAI has jumped. In an example considered in FIG. 12, 5 low priority PDSCHs are transmitted, however, the 1^{st} low priority PUCCH corresponding to first two PDSCHs is cancelled due to some reasons, e.g., due to prioritizations as shown in this example. When gNB allocates 4^{th} low priority PDSCH, it can increase the DAI in corresponding DCI to 3 instead of using 2, in order to accommodate dropped HARQ-ACK of PDSCH 1 and PDSCH 2. Hence while placing HARQ-ACK bits in the UCI 2 corresponding to low priority PUCCH_2, the CB will contain HARQ-ACK bit of 3^{rd} low priority PDSCH, then 1^{st} and 2^{nd} low priority PDSCHs and last the 4^{th} PDSCH, i.e., dropped HARQ-ACKs bits are placed where DAI has jumped. Note, FIG. 12 can be seen as embodiment depicting more complex behavior than in FIG. 11.

C. Methods for Transmission of Dropped Low Priority CB without Explicit Indication

In this embodiment, upon cancellation of the transmission of the low priority HARQ-ACK codebook due to overlapping with the high priority PUCCH, the UE assumes that it is expected to multiplex the low priority CB with the HARQ-ACK to be transmitted in a later PUCCH carrying low priority HARQ-ACK. The later PUCCH can be the next immediate PUCCH carrying low-priority HARQ-ACK. Alternatively, it can be the earliest PUCCH after a certain time gap requirement from the dropped PUCCH.

In this case, the UE is expected to multiplex the low priority CB corresponding to the canceled PUCCH with the new low priority CB to form a combined low priority CB for transmission in a PUCCH. The new CB and the CB corresponding to dropped PUCCH are concatenated in the combined CB, where the combined CB can start or end with the low priority CB corresponding to cancelled PUCCH.

The UE is not expected that the counter DAI for the new CB be affected by the earlier DAI value corresponding the low priority CB with canceled PUCCH.

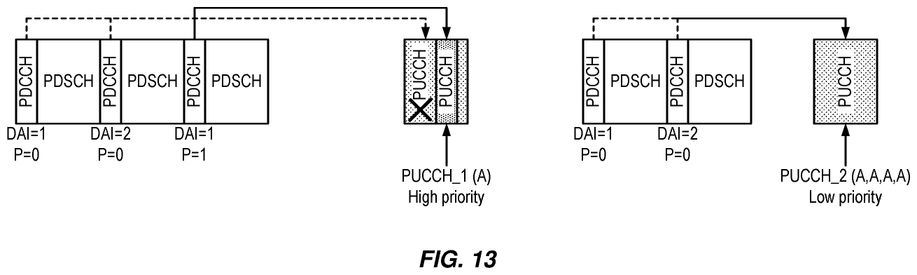

An example of transmission of dropped codebook in next PUCCH is shown in FIG. 13.

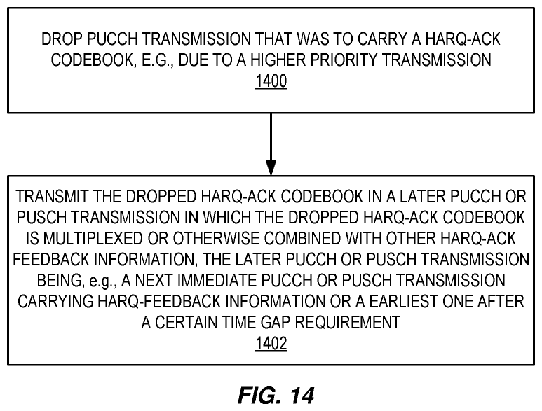

FIG. 14 is a flow chart that illustrates the operation of a UE 812 in accordance with at least some of the embodiments described in this section. As illustrated, the UE 812 drops PUCCH transmission that was to carry a HARQ-ACK codebook (e.g., a low-priority HARQ-ACK codebook) comprising HARQ-ACK information for one or more respective PDSCH transmissions (step 1400). The HARQ-ACK codebook that was to be carried in the dropped PUCCH transmission is sometimes referred to herein as dropped HARQ-ACK codebook. The PUCCH transmission may be dropped due to, e.g., overlap with a higher priority transmission (e.g., a higher priority PUCCH transmission with HARQ-ACK feedback information). In some embodiments, dropping the first transmission at step 1400 includes dropping the first transmission due to a higher priority transmission. Alternatively, in some embodiments, dropping the first transmission at step 1400 includes dropping the first transmission due to a transmission that includes higher priority HARQ-ACK feedback information.

Upon dropping the PUCCH transmission, the UE 812 transmits the dropped HARQ-ACK codebook in a later PUCCH or PUSCH transmission by multiplexing or otherwise combining the dropped low-priority HARQ-ACK codebook with other (e.g., low priority) HARQ-ACK feedback information, where the later PUCCH or PUSCH transmission is a next immediate PUCCH or PUSCH transmission that carries HARQ-ACK feedback information or an earliest PUCCH or PUSCH transmission that carries HARQ-ACK feedback information after a certain (e.g., predefined or configured) required amount of time (step 1402).

In some embodiments, transmitting the second transmission at step 1402 includes including the at least a portion of the dropped HARQ-ACK codebook in the second transmission responsive to a counter DAI based determination. In some embodiments, the second transmission is an immediate next PUCCH or PUSCH transmission that includes HARQ-ACK feedback information (e.g., low priority HARQ-ACK feedback information). Alternatively, in some implementations, the second transmission is an earliest PUCCH or PUSCH transmission that comprises HARQ-ACK feedback information (e.g., low priority HARQ-ACK feedback information) following a certain required time gap. In some embodiments, the second transmission in which the dropped HARQ-ACK codebook is to be included is explicitly indicated to the wireless communication device (e.g., from an associated base station). In some embodiments, the second transmission is a transmission due to which the first transmission was dropped (e.g., a higher priority transmission).

In some embodiments, the second transmission is determined based on one or more rules. Alternatively, or additionally, in some embodiments, the second transmission is determined based on PDSCH grouping in enhanced dynamic codebook.

D. Methods for Transmission of Dropped Low Priority CB Based on Explicit Indications

In this embodiment, upon cancellation of the transmission of the low priority HARQ-ACK codebook due to overlapping with the high priority PUCCH, the UE assumes that it is expected to multiplex the low priority CB with the HARQ-ACK to be transmitted in a later PUCCH carrying low priority HARQ-ACK. The later PUCCH is determined by a flag that is configured in the DCI indicating PUCCH: If the flag is triggered in the DCI, the previously low priority CB corresponding to dropped PUCCH should be multiplexed with the CB associated to the later PUCCH, and should not be multiplexed, otherwise.

In this case, the UE is expected to multiplex the low priority CB corresponding to the canceled PUCCH with the new low priority CB to form a combined low priority CB for transmission in a PUCCH. The new CB and the CB corresponding to dropped PUCCH are concatenated in the combined CB, where the combined CB can start or end with the low priority CB corresponding to cancelled PUCCH.

The UE is not expected that the counter DAI for the new CB be affected by the earlier DAI value corresponding the low priority CB with canceled PUCCH.

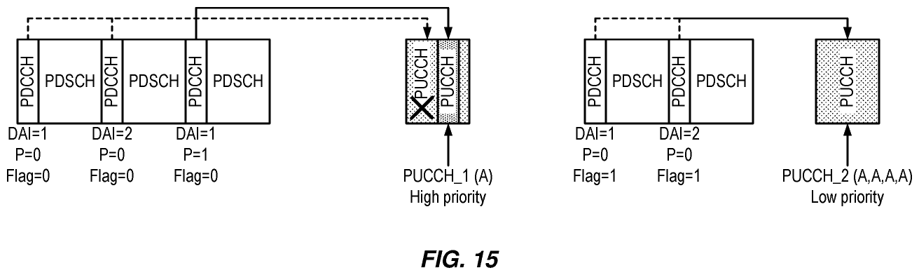

An example of transmission of dropped CB in next PUCCH based on explicit indication is shown in FIG. 15.

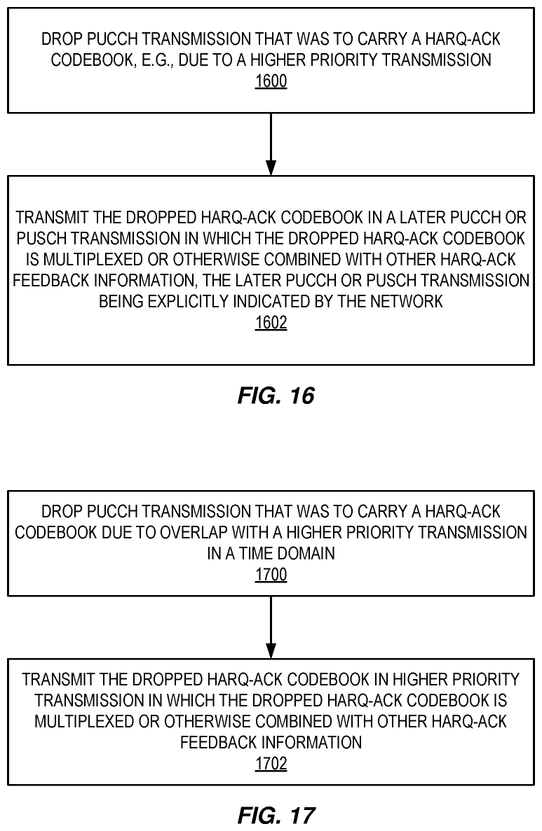

FIG. 16 is a flow chart that illustrates the operation of a UE 812 in accordance with at least some of the embodiments described the section of the present disclosure titled “Methods for transmission of dropped low priority CB based on explicit indications”. As illustrated, the UE 812 drops PUCCH transmission that was to carry a HARQ-ACK codebook (e.g., a low-priority HARQ-ACK codebook) comprising HARQ-ACK information for one or more respective PDSCH transmissions (step 1600). The HARQ-ACK codebook that was to be carried in the dropped PUCCH transmission is sometimes referred to herein as dropped HARQ-ACK codebook. The PUCCH transmission may be dropped due to, e.g., overlap with a higher priority transmission (e.g., a higher priority PUCCH transmission with HARQ-ACK feedback information). In some embodiments, dropping the first transmission at step 1600 includes dropping the first transmission due to a higher priority transmission. Alternatively, in some embodiments, dropping the first transmission at step 1600 includes dropping the first transmission due to a transmission that includes higher priority HARQ-ACK feedback information.

Upon dropping the PUCCH transmission, the UE 812 transmits the dropped HARQ-ACK codebook in a later PUCCH or PUSCH transmission by multiplexing or otherwise combining the dropped low-priority HARQ-ACK codebook with other (e.g., low priority) HARQ-ACK feedback information, where the later PUCCH or PUSCH transmission is explicitly indicated by the network (e.g., by the aforementioned flag) (step 1602).

In some embodiments, transmitting the second transmission at step 1602 includes including the at least a portion of the dropped HARQ-ACK codebook in the second transmission responsive to a counter DAI based determination. In some embodiments, the second transmission is an immediate next PUCCH or PUSCH transmission that includes HARQ-ACK feedback information (e.g., low priority HARQ-ACK feedback information). Alternatively, in some implementations, the second transmission is an earliest PUCCH or PUSCH transmission that comprises HARQ-ACK feedback information (e.g., low priority HARQ-ACK feedback information) following a certain required time gap. In some embodiments, the second transmission in which the dropped HARQ-ACK codebook is to be included is explicitly indicated to the wireless communication device (e.g., from an associated base station). In some embodiments, the second transmission is a transmission due to which the first transmission was dropped (e.g., a higher priority transmission).

In some embodiments, the second transmission is determined based on one or more rules. Alternatively, or additionally, in some embodiments, the second transmission is determined based on PDSCH grouping in enhanced dynamic codebook.

The above procedures can continue until the low priority CB corresponding to the first canceled PUCCH is transmitted. Alternatively, for a given low priority CB with canceled PUCCH, the procedure can continue maximum Y times, where either a default value is assumed for Y, e.g. Y=1, or Y is configured by higher layers. In this case, the UE can assume that it is not expected to combine a low priority CB corresponding to a cancelled PUCCH in another low priority CB more than Y times.

In one non-limiting embodiment, besides a normal DAI (as in Rel 15 or Rel 16), a new DAI dropped is introduced which accounts for dropped HARQ-ACKs. In some of the above embodiment, the same DAI counter includes new PDSCH allocation and also PDSCH with dropped HARQ-ACKs. But in this embodiment, rather two DAIs will be configured in the DCI while doing new PDSCH allocation. This allows cleaner solution as it separates the legacy DAI from the DALdropped which only counts the dropped HARQ-ACKs for the past PDSCHs.

In another embodiment, the PDSCHs corresponding to dropped HARQ-ACK bits are implicitly assigned a PDSCH group index 2, with PDSCHs corresponding to successfully transmitted HARQ-ACK bits assigned a PDSCH group index 1. Then the DCI can explicitly request re-attempt of previously dropped HARQ-ACK bits by request HARQ-ACK feedback of PDSCH group index 2. In the DCI, the PDSCH group index field is separate from (HARQ-ACK) priority indicator field.

In one non-limiting embodiment, dropped HARQ-ACKs of SPS PDSCHs can be indicated with corresponding increment in DAI counter in the DCI demanding HARQ-ACKs including the dropped ones.

In one non-limiting embodiment, the HARQ-ACK from previous codebooks is multiplexed also if it was not dropped when multiplexing is explicitly indicated.

In one non-limiting embodiment, the set of additional PDSCHs to be acknowledged by multiplexing with the current HARQ-ACKs is determined as follows:
1. All PDSCHs for which HARQ-ACK is sent in the current PUCCH according to the Rd. rules for dynamic (Type 2) CBs belong to level 0.
2. The latest PDSCH that is not in level 0 and for which HARQ-ACK was originally scheduled to be transmitted earlier than the current PUCCH belongs to level 1. All other PDSCH which HARQ-ACKs were originally scheduled to be sent together with the latest PDSCH that was not in level 0 also belong to level 1.
3. The latest PDSCH that is not in level n and for which HARQ-ACK was originally scheduled to be transmitted earlier than the HARQ-ACK for level n belongs to level n+1. All other PDSCH which HARQ-ACKs were originally scheduled to be sent together with the latest PDSCH that was not in level n+1 also belong to level n+1.

In some non-limiting embodiments the PDSCHs only contain PDSCHs with the same priority.

In some non-limiting embodiments the gNB can indicate which levels of PDSCH that HARQ-ACK should be reported for.

In one non-limiting embodiment the gNB can indicate with a single bit in DCI which levels to include HARQ-ACK for. If the bit is set 0, only level 0 is reported. If set to 1, levels 0 up to Y are reported, where Y can be either RRC configured or specified. A likely value of Y to use is 1.

In one non-limiting embodiment the gNB can indicate with a bitmap which levels to report HARQ-ACK for. The UE always reports HARQ-ACK feedback for level 0. A bitmap of length n is included to indicate which additional levels from 1 to n to report HARQ-ACK feedback for.

E. Structure of the Codebook Including the Dropped Codebook

In one non-limiting embodiment, the dropped HARQ-ACKs of the past PDSCHs can be placed in the Type-2 CB with one of the following options
The initial part in the CB contains HARQ-ACK bits corresponding to dropped HARQ-ACKs, then rest of the part is based on Type-2 CB as in Rel-16, i.e.,
   CB=[[HARQ-ACK bits corresponding to dropped HARQ-ACKs] Union

[HARQ-ACK bits corresponding to non-dropped HARQ-ACKs for dynamic PDSCHs] Union [HARQ-ACK bits corresponding to non-dropped HARQ-ACKs SPS PDSCHs]]
The middle part contains HARQ-ACK bits corresponding to dropped HARQ-ACKs, then rest of the part is based on Type-2 CB as in Rel-16, i.e.,
   CB=[[HARQ-ACK bits corresponding to non-dropped HARQ-ACKs for dynamic PDSCHs] Union [HARQ-ACK bits corresponding to dropped HARQ-ACKs] Union [HARQ-ACK bits corresponding to non-dropped HARQ-ACKs SPS PDSCHs]]
The last part contains HARQ-ACK bits corresponding to dropped HARQ-ACKs, then rest of the part is based on Type-2 CB as in Rel-16, i.e.,
   CB=[[HARQ-ACK bits corresponding to non-dropped HARQ-ACKs for dynamic PDSCHs] [HARQ-ACK bits corresponding to non-dropped HARQ-ACKs SPS PDSCHs] Union [HARQ-ACK bits corresponding to dropped HARQ-ACKs] Union]
In another option, the HARQ-ACK bits corresponding to dropped HARQ-ACKs of dynamic and SPS PDCCHs are kept separate in the CB
   One option is they are appending after their respective CBs, i.e.,
      CB=[[HARQ-ACK bits corresponding to non-dropped HARQ-ACKs for dynamic PDSCHs] Union [HARQ-ACK bits corresponding to dropped HARQ-ACKs for dynamic PDSCHs] Union [HARQ-ACK bits corresponding to non-dropped HARQ-ACKs SPS PDSCHs] Union [HARQ-ACK bits corresponding to dropped HARQ-ACKs for SPS PDSCHs]]
   They are attached before their respective CBs, i.e.,
      CB=[[HARQ-ACK bits corresponding to dropped HARQ-ACKs for dynamic PDSCHs] Union [HARQ-ACK bits corresponding to non-dropped HARQ-ACKs for dynamic PDSCHs] Union [HARQ-ACK bits corresponding to dropped HARQ-ACKs for SPS PDSCHs] Union [HARQ-ACK bits corresponding to non-dropped HARQ-ACKs SPS PDSCHs]]
   Both are attached in the beginning, i.e.,
      CB=[[HARQ-ACK bits corresponding to dropped HARQ-ACKs for dynamic PDSCHs] Union [HARQ-ACK bits corresponding to dropped HARQ-ACKs for SPS PDSCHs] Union [HARQ-ACK bits corresponding to non-dropped HARQ-ACKs for dynamic PDSCHs] Union [HARQ-ACK bits corresponding to non-dropped HARQ-ACKs SPS PDSCHs]]
   Both are attached/appended in the end, i.e.,
      CB=[[HARQ-ACK bits corresponding to non-dropped HARQ-ACKs for dynamic PDSCHs] Union [HARQ-ACK bits corresponding to non-dropped HARQ-ACKs SPS PDSCHs] Union [HARQ-ACK bits corresponding to dropped HARQ-ACKs for dynamic PDSCHs] Union [HARQ-ACK bits corresponding to dropped HARQ-ACKs for SPS PDSCHs]]
Reference: The current Rel-16 CB is derived as where non-dropped HARQ-ACKs are placed in the beginning and the non-dropped HARQ-ACKs for SPS are appended
   CB=[[HARQ-ACK bits corresponding to non-dropped HARQ-ACKs for dynamic PDSCHs] Union [HARQ-ACK bits corresponding to non-dropped HARQ-ACKs SPS PDSCHs]]

In another embodiment, multi-part HARQ-ACK can be constructed, with HARQ-ACK-part1 for HARQ-ACK bits that are constructed normally for the current slot (or sub-slot), and with HARQ-ACK-part2 containing the previously dropped HARQ-ACK codebook. HARQ-ACK-part1 and HARQ-ACK-part2 are separately processed, each being constructed using the normal HARQ-ACK codebook procedure. HARQ-ACK-part1 and HARQ-ACK-part2 may go through the processing chain separately, including encoding, rate-matching, modulation, etc.

F. Methods for Transmission of Dropped Low Priority HARQ-ACK Based on an Implicit Rule

In this embodiment, when a high priority PUCCH with HARQ-ACK causes a low priority PUCCH with HARQ-ACK to be dropped due to overlapping/collision, the UE multiplexes HARQ-ACK bits of the dropped low priority PUCCH into the HARQ-ACK codebook of the high priority PUCCH.

FIG. 17 is a flow chart that illustrates the operation of a UE 812 in accordance with at least some of the embodiments described in this section. As illustrated, the UE 812 drops PUCCH transmission that was to carry a HARQ-ACK codebook (e.g., a low-priority HARQ-ACK codebook) comprising HARQ-ACK information for one or more respective PDSCH transmissions (step 1700). The HARQ-ACK codebook that was to be carried in the dropped PUCCH transmission is sometimes referred to herein as dropped HARQ-ACK codebook. The PUCCH transmission may be dropped due to, e.g., overlap with a higher priority transmission within a time domain (e.g., a higher priority PUCCH transmission with HARQ-ACK feedback information). In some embodiments, dropping the first transmission at step 1700 includes dropping the first transmission due to a higher priority transmission. Alternatively, in some embodiments, dropping the first transmission at step 1700 includes dropping the first transmission due to a transmission that includes higher priority HARQ-ACK feedback information.

Upon dropping the PUCCH transmission, the UE 812 transmits the dropped HARQ-ACK codebook in a later PUCCH or PUSCH transmission by multiplexing or otherwise combining the dropped low-priority HARQ-ACK codebook with other (e.g., low priority) HARQ-ACK feedback information, where the later PUCCH or PUSCH transmission is a next immediate PUCCH or PUSCH transmission that carries HARQ-ACK feedback information or an earliest PUCCH or PUSCH transmission that carries HARQ-ACK feedback information after a certain (e.g., predefined or configured) required amount of time (step 1702).

In some embodiments, transmitting the second transmission at step 1702 includes including the at least a portion of the dropped HARQ-ACK codebook in the second transmission responsive to a counter DAI based determination. In some embodiments, the second transmission is an immediate next PUCCH or PUSCH transmission that includes HARQ-ACK feedback information (e.g., low priority HARQ-ACK feedback information). Alternatively, in some implementations, the second transmission is an earliest PUCCH or PUSCH transmission that comprises HARQ-ACK feedback information (e.g., low priority HARQ-ACK feedback information) following a certain required time gap. In some embodiments, the second transmission in which the dropped HARQ-ACK codebook is to be included is explicitly indicated to the wireless communication device (e.g., from an associated base station). In some embodiments, the second transmission is a transmission due to which the first transmission was dropped (e.g., a higher priority transmission).

In some embodiments, the second transmission is determined based on one or more rules. Alternatively, or additionally, in some embodiments, the second transmission is determined based on PDSCH grouping in enhanced dynamic codebook.

The multiplexing can be based on appending or prepending the low-priority HARQ-ACK bits to the high priority HARQ-ACK CB. The above rule is applied when a UE is configured with dynamic HARQ code book or enhanced dynamic HARQ code book, as in Rel-16.

The above rule is performed after overlapping is resolved between PUCCH of the same priority following Rel-15 procedures.

In one version of the above embodiment, the implicit rule of multiplexing HARQ-ACK bits of the dropped low priority PUCCH into the high priority HARQ-ACK codebook of the PUCCH which causes dropping is applied only if
the DCI scheduling PDSCH with the high priority PUCCH starts after the last DCI associated with the dropped low priority PUCCH if the dropped low priority PUCCH corresponds to dynamically scheduled PDSCH or SPS PDSCH release, or
the DCI scheduling PDSCH with the high priority PUCCH starts after the SPS PDSCH associated with the dropped low priority PUCCH if the dropped low priority PUCCH is in response to semi-persistent scheduled PDSCH reception.

In another version, the above rule is performed only if a UE is configured with a higher layer parameter indicating such multiplexing behavior. If the UE is not configured with such a parameter, HARQ-ACK bits of the dropped low priority PUCCH are not multiplexed onto the high priority HARQ-ACK codebook.

If there are more than two levels of priority for PUCCH carrying HARQ-ACK, the above rule can be extended to the cases where a higher priority PUCCH with HARQ-ACK causes a lower priority PUCCH with HARQ-ACK to be dropped.

The PUCCH resource to be used for carrying the multiplexed HARQ-ACK can be based on the PUCCH resource originally indicated for the high-priority PUCCH. Alternatively, it can be derived based on a new UCI payload size after multiplexing similarly as in the Rel-15 multiplexing procedure for determining the PUCCH resource set.

G. Methods for Transmission of Dropped Low Priority HARQ-ACK Based on PDSCH Grouping in Enhanced Dynamic Codebook

In this embodiment, the Rel-16 procedures for transmission of enhanced dynamic HARQ-ACK codebook are reused to enable retransmission of a dropped low priority CB due to prioritization.

The following assumptions and modifications or reinterpretation of the procedures are considered:
Each PDSCH group is associated to a priority. For example, PDSCH group 1 is associated to low priority and PDSCH group 2 is associated to high priority.
   The association can be done by default similarly to example above, or by RRC configuration.
When a DCI schedules a PDSCH, there should be alignment between the PDSCH group ID and corresponding associated priority. For example, only PDSCH group 1 can be scheduled by a DCI indication low priority and only PDSCH group 2 can be scheduled by a DCI indication high priority.
With above association, when a DCI request the HARQ-ACK feedback of both PDSCH groups, the UE can transmit both low priority and high priority code books, following the Rel-16 procedures for enhance dynamic HARQ codebook. The request of both codebooks can be triggered when UE has dropped a low priority HARQ-ACK codebook.

Note that the parameters of the PUCCH resource follow the PUCCH Config 1E that is aligned with the priority assumed for the DCI.

II. Additional Aspects

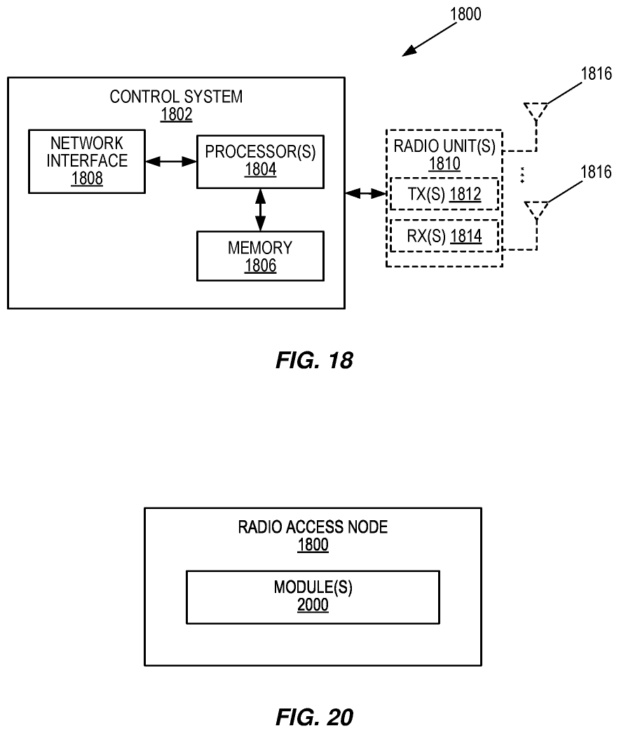

FIG. 18 is a schematic block diagram of a radio access node 1800 according to some embodiments of the present disclosure. Optional features are represented by dashed boxes. The radio access node 1800 may be, for example, a base station 802 or 806 or a network node that implements all or part of the functionality of the base station 802 or gNB described herein. As illustrated, the radio access node 1800 includes a control system 1802 that includes one or more processors 1804 (e.g., Central Processing Units (CPUs), Application Specific Integrated Circuits (ASICs), Field Programmable Gate Arrays (FPGAs), and/or the like), memory 1806, and a network interface 1808. The one or more processors 1804 are also referred to herein as processing circuitry. In addition, the radio access node 1800 may include one or more radio units 1810 that each includes one or more transmitters 1812 and one or more receivers 1814 coupled to one or more antennas 1816. The radio units 1810 may be referred to or be part of radio interface circuitry. In some embodiments, the radio unit(s) 1810 is external to the control system 1802 and connected to the control system 1802 via, e.g., a wired connection (e.g., an optical cable). However, in some other embodiments, the radio unit(s) 1810 and potentially the antenna(s) 1816 are integrated together with the control system 1802. The one or more processors 1804 operate to provide one or more functions of a radio access node 1800 as described herein. In some embodiments, the function(s) are implemented in software that is stored, e.g., in the memory 1806 and executed by the one or more processors 1804.

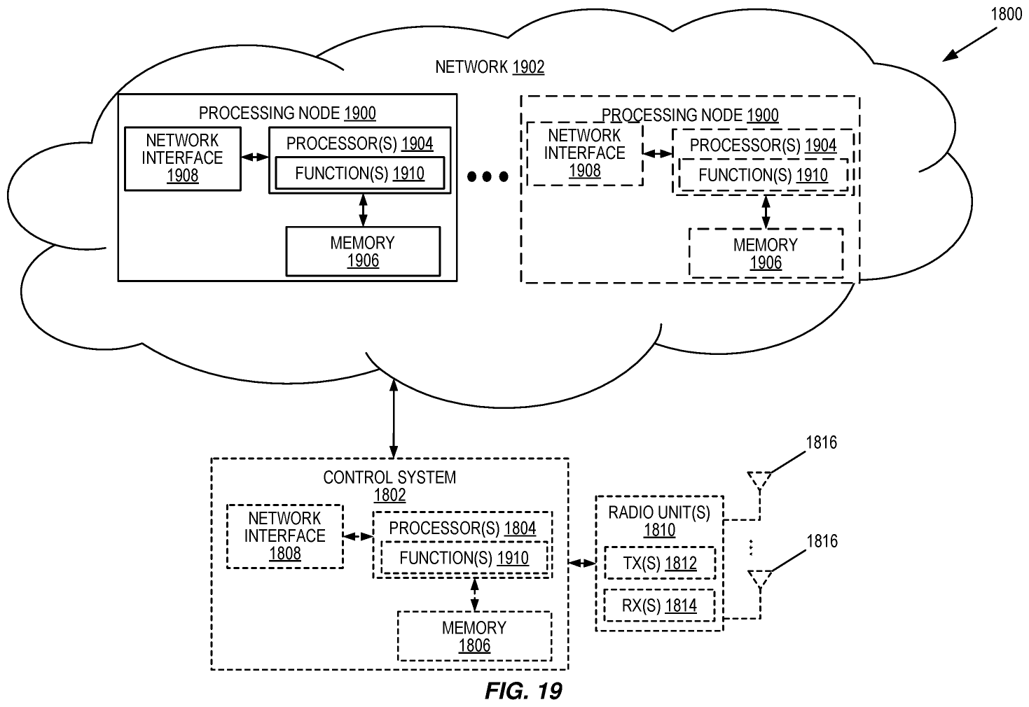

FIG. 19 is a schematic block diagram that illustrates a virtualized embodiment of the radio access node 1800 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1800 in which at least a portion of the functionality of the radio access node 1800 is implemented as a virtual component(s) (e.g., via a virtual machine(s) executing on a physical processing node(s) in a network(s)). As illustrated, in this example, the radio access node 1800 may include the control system 1802 and/or the one or more radio units 1810, as described above. The control system 1802 may be connected to the radio unit(s) 1810 via, for example, an optical cable or the like. The radio access node 1800 includes one or more processing nodes 1900 coupled to or included as part of a network(s) 1902. If present, the control system 1802 or the radio unit(s) are connected to the processing node(s) 1900 via the network 1902. Each processing node 1900 includes one or more processors 1904 (e.g., CPUs, ASICs, FPGAs, and/or the like), memory 1906, and a network interface 1908.

In this example, functions 1910 of the radio access node 1800 described herein are implemented at the one or more processing nodes 1900 or distributed across the one or more processing nodes 1900 and the control system 1802 and/or the radio unit(s) 1810 in any desired manner. In some particular embodiments, some or all of the functions 1910 of the radio access node 1800 described herein are implemented as virtual components executed by one or more virtual machines implemented in a virtual environment(s) hosted by the processing node(s) 1900. As will be appreciated by one of ordinary skill in the art, additional signaling or communication between the processing node(s) 1900 and the control system 1802 is used in order to carry out at least some of the desired functions 1910. Notably, in some embodiments, the control system 1802 may not be included, in which case the radio unit(s) 1810 communicate directly with the processing node(s) 1900 via an appropriate network interface(s).

In some embodiments, a computer program including instructions which, when executed by at least one processor, causes the at least one processor to carry out the functionality of radio access node 1800 or a node (e.g., a processing node 1900) implementing one or more of the functions 1910 of the radio access node 1800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 20 is a schematic block diagram of the radio access node 1800 according to some other embodiments of the present disclosure. The radio access node 1800 includes one or more modules 2000, each of which is implemented in software. The module(s) 2000 provide the functionality of the radio access node 1800 described herein. This discussion is equally applicable to the processing node 1900 of FIG. 19 where the modules 2000 may be implemented at one of the processing nodes 1900 or distributed across multiple processing nodes 1900 and/or distributed across the processing node(s) 1900 and the control system 1802.

FIG. 21 is a schematic block diagram of a wireless communication device 2100 (e.g., a UE such as the UE 812) according to some embodiments of the present disclosure. As illustrated, the wireless communication device 2100 includes one or more processors 2102 (e.g., CPUs, ASICs, FPGAs, and/or the like), memory 2104, and one or more transceivers 2106 each including one or more transmitters 2108 and one or more receivers 2110 coupled to one or more antennas 2112. The transceiver(s) 2106 includes radio-front end circuitry connected to the antenna(s) 2112 that is configured to condition signals communicated between the antenna(s) 2112 and the processor(s) 2102, as will be appreciated by on of ordinary skill in the art. The processors 2102 are also referred to herein as processing circuitry. The transceivers 2106 are also referred to herein as radio circuitry. In some embodiments, the functionality of the wireless communication device 2100 described above (e.g., functionality of a UE such as the UE 812 described above) may be fully or partially implemented in software that is, e.g., stored in the memory 2104 and executed by the processor(s) 2102. Note that the wireless communication device 2100 may include additional components not illustrated in FIG. 21 such as, e.g., one or more user interface components (e.g., an input/output interface including a display, buttons, a touch screen, a microphone, a speaker(s), and/or the like and/or any other components for allowing input of information into the wireless communication device 2100 and/or allowing output of information from the wireless communication device 2100), a power supply (e.g., a battery and associated power circuitry), etc.

In some embodiments, a computer program including instructions which, when executed by at least one processor, causes the at least one processor to carry out the functionality of the wireless communication device 2100 (e.g., functionality of a UE such as the UE 812 described above) according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

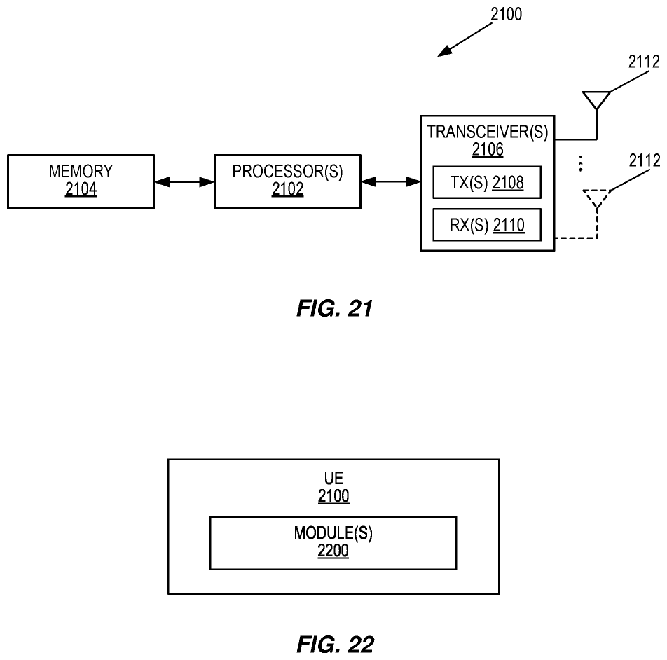

FIG. 22 is a schematic block diagram of the wireless communication device 2100 according to some other embodiments of the present disclosure. The wireless communication device 2100 includes one or more modules 2200, each of which is implemented in software. The module(s) 2200 provide the functionality of the wireless communication device 2100 described herein (e.g., functionality of a UE such as the UE 812 described above).

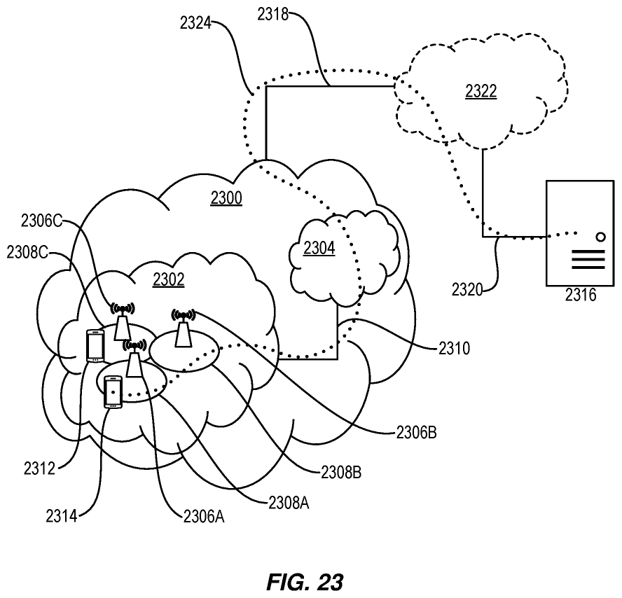

With reference to FIG. 23, in accordance with an embodiment, a communication system includes a telecommunication network 2300, such as a 3GPP-type cellular network, which comprises an access network 2302, such as a RAN, and a core network 2304. The access network 2302 comprises a plurality of base stations 2306A, 2306B, 2306C, such as Node Bs, eNBs, gNBs, or other types of wireless Access Points (APs), each defining a corresponding coverage area 2308A, 2308B, 2308C. Each base station 2306A, 2306B, 2306C is connectable to the core network 2304 over a wired or wireless connection 2310. A first UE 2312 located in coverage area 2308C is configured to wirelessly connect to, or be paged by, the corresponding base station 2306C. A second UE 2314 in coverage area 2308A is wirelessly connectable to the corresponding base station 2306A. While a plurality of UEs 2312, 2314 are illustrated in this example, the disclosed embodiments are equally applicable to a situation where a sole UE is in the coverage area or where a sole UE is connecting to the corresponding base station 2306.

The telecommunication network 2300 is itself connected to a host computer 2316, which may be embodied in the hardware and/or software of a standalone server, a cloud-implemented server, a distributed server, or as processing resources in a server farm. The host computer 2316 may be under the ownership or control of a service provider, or may be operated by the service provider or on behalf of the service provider. Connections 2318 and 2320 between the telecommunication network 2300 and the host computer 2316 may extend directly from the core network 2304 to the host computer 2316 or may go via an optional intermediate network 2322. The intermediate network 2322 may be one of, or a combination of more than one of, a public, private, or hosted network; the intermediate network 2322, if any, may be a backbone network or the Internet; in particular, the intermediate network 2322 may comprise two or more sub-networks (not shown).

The communication system of FIG. 23 as a whole enables connectivity between the connected UEs 2312, 2314 and the host computer 2316. The connectivity may be described as an Over-the-Top (OTT) connection 2324. The host computer 2316 and the connected UEs 2312, 2314 are configured to communicate data and/or signaling via the OTT connection 2324, using the access network 2302, the core network 2304, any intermediate network 2322, and possible further infrastructure (not shown) as intermediaries. The OTT connection 2324 may be transparent in the sense that the participating communication devices through which the OTT connection 2324 passes are unaware of routing of uplink and downlink communications. For example, the base station 2306 may not or need not be informed about the past routing of an incoming downlink communication with data originating from the host computer 2316 to be forwarded (e.g., handed over) to a connected UE 2312. Similarly, the base station 2306 need not be aware of the future routing of an outgoing uplink communication originating from the UE 2312 towards the host computer 2316.

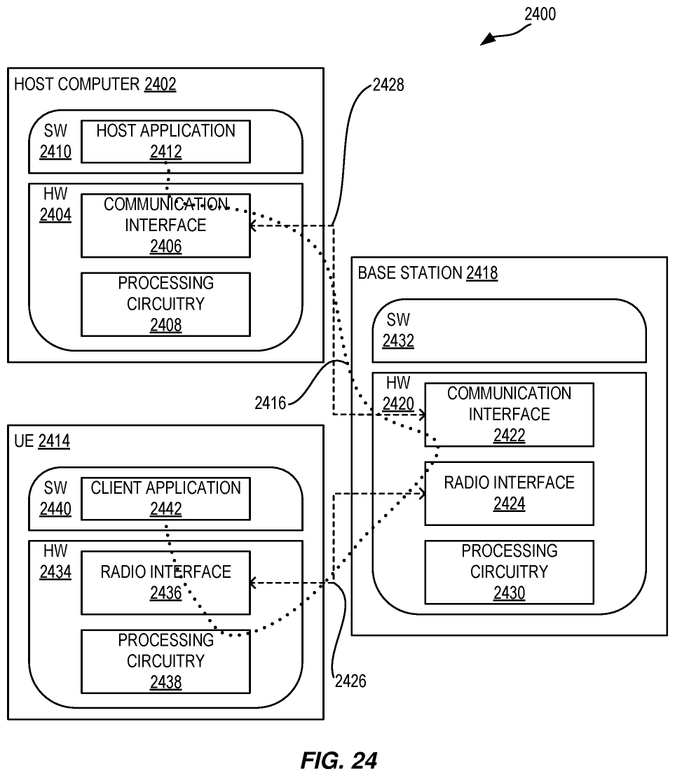

Example implementations, in accordance with an embodiment, of the UE, base station, and host computer discussed in the preceding paragraphs will now be described with reference to FIG. 24. In a communication system 2400, a host computer 2402 comprises hardware 2404 including a communication interface 2406 configured to set up and maintain a wired or wireless connection with an interface of a different communication device of the communication system 2400. The host computer 2402 further comprises processing circuitry 2408, which may have storage and/or processing capabilities. In particular, the processing circuitry 2408 may comprise one or more programmable processors, ASICs, FPGAs, or combinations of these (not shown) adapted to execute instructions. The host computer 2402 further comprises software 2410, which is stored in or accessible by the host computer 2402 and executable by the processing circuitry 2408. The software 2410 includes a host application 2412. The host application 2412 may be operable to provide a service to a remote user, such as a UE 2414 connecting via an OTT connection 2416 terminating at the UE 2414 and the host computer 2402. In providing the service to the remote user, the host application 2412 may provide user data which is transmitted using the OTT connection 2416.

The communication system 2400 further includes a base station 2418 provided in a telecommunication system and comprising hardware 2420 enabling it to communicate with the host computer 2402 and with the UE 2414. The hardware 2420 may include a communication interface 2422 for setting up and maintaining a wired or wireless connection with an interface of a different communication device of the communication system 2400, as well as a radio interface 2424 for setting up and maintaining at least a wireless connection 2426 with the UE 2414 located in a coverage area (not shown in FIG. 24) served by the base station 2418. The communication interface 2422 may be configured to facilitate a connection 2428 to the host computer 2402. The connection 2428 may be direct or it may pass through a core network (not shown in FIG. 24) of the telecommunication system and/or through one or more intermediate networks outside the telecommunication system. In the embodiment shown, the hardware 2420 of the base station 2418 further includes processing circuitry 2430, which may comprise one or more programmable processors, ASICs, FPGAs, or combinations of these (not shown) adapted to execute instructions. The base station 2418 further has software 2432 stored internally or accessible via an external connection.

The communication system 2400 further includes the UE 2414 already referred to. The UE's 2414 hardware 2434 may include a radio interface 2436 configured to set up and maintain a wireless connection 2426 with a base station serving a coverage area in which the UE 2414 is currently located. The hardware 2434 of the UE 2414 further includes processing circuitry 2438, which may comprise one or more programmable processors, ASICs, FPGAs, or combinations of these (not shown) adapted to execute instructions. The UE 2414 further comprises software 2440, which is stored in or accessible by the UE 2414 and executable by the processing circuitry 2438. The software 2440 includes a client application 2442. The client application 2442 may be operable to provide a service to a human or non-human user via the UE 2414, with the support of the host computer 2402. In the host computer 2402, the executing host application 2412 may communicate with the executing client application 2442 via the OTT connection 2416 terminating at the UE 2414 and the host computer 2402. In providing the service to the user, the client application 2442 may receive request data from the host application 2412 and provide user data in response to the request data. The OTT connection 2416 may transfer both the request data and the user data. The client application 2442 may interact with the user to generate the user data that it provides.

It is noted that the host computer 2402, the base station 2418, and the UE 2414 illustrated in FIG. 24 may be similar or identical to the host computer 2316, one of the base stations 2306A, 2306B, 2306C, and one of the UEs 2312, 2314 of FIG. 23, respectively. This is to say, the inner workings of these entities may be as shown in FIG. 24 and independently, the surrounding network topology may be that of FIG. 23.

In FIG. 24, the OTT connection 2416 has been drawn abstractly to illustrate the communication between the host computer 2402 and the UE 2414 via the base station 2418 without explicit reference to any intermediary devices and the precise routing of messages via these devices. The network infrastructure may determine the routing, which may be configured to hide from the UE 2414 or from the service provider operating the host computer 2402, or both. While the OTT connection 2416 is active, the network infrastructure may further take decisions by which it dynamically changes the routing (e.g., on the basis of load balancing consideration or reconfiguration of the network).

The wireless connection 2426 between the UE 2414 and the base station 2418 is in accordance with the teachings of the embodiments described throughout this disclosure. One or more of the various embodiments improve the performance of OTT services provided to the UE 2414 using the OTT connection 2416, in which the wireless connection 2426 forms the last segment.

A measurement procedure may be provided for the purpose of monitoring data rate, latency, and other factors on which the one or more embodiments improve. There may further be an optional network functionality for reconfiguring the OTT connection 2416 between the host computer 2402 and the UE 2414, in response to variations in the measurement results. The measurement procedure and/or the network functionality for reconfiguring the OTT connection 2416 may be implemented in the software 2410 and the hardware 2404 of the host computer 2402 or in the software 2440 and the hardware 2434 of the UE 2414, or both. In some embodiments, sensors (not shown) may be deployed in or in association with communication devices through which the OTT connection 2416 passes; the sensors may participate in the measurement procedure by supplying values of the monitored quantities exemplified above, or supplying values of other physical quantities from which the software 2410, 2440 may compute or estimate the monitored quantities. The reconfiguring of the OTT connection 2416 may include message format, retransmission settings, preferred routing, etc.; the reconfiguring need not affect the base station 2418, and it may be unknown or imperceptible to the base station 2418. Such procedures and functionalities may be known and practiced in the art. In certain embodiments, measurements may involve proprietary UE signaling facilitating the host computer 2402's measurements of throughput, propagation times, latency, and the like. The measurements may be implemented in that the software 2410 and 2440 causes messages to be transmitted, in particular empty or ‘dummy’ messages, using the OTT connection 2416 while it monitors propagation times, errors, etc.

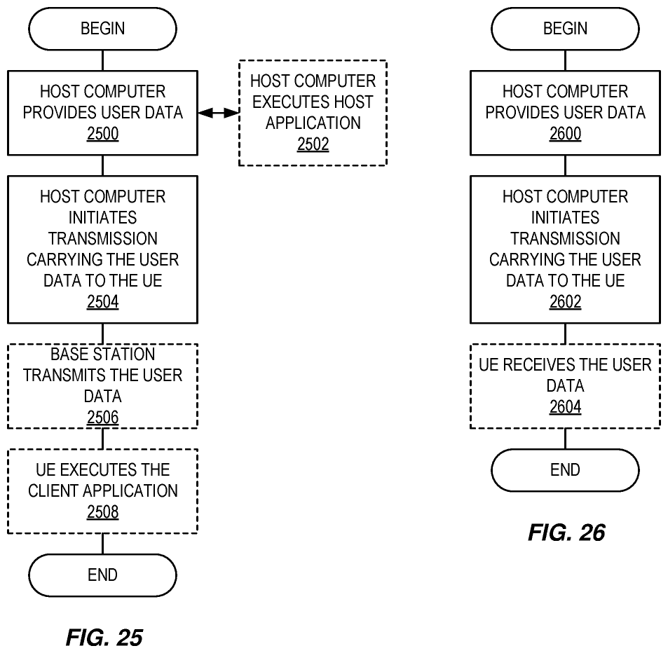

FIG. 25 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 25 will be included in this section. In step 2500, the host computer provides user data. In sub-step 2502 (which may be optional) of step 2500, the host computer provides the user data by executing a host application. In step 2504, the host computer initiates a transmission carrying the user data to the UE. In step 2506 (which may be optional), the base station transmits to the UE the user data which was carried in the transmission that the host computer initiated, in accordance with the teachings of the embodiments described throughout this disclosure. In step 2508 (which may also be optional), the UE executes a client application associated with the host application executed by the host computer.

FIG. 26 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 26 will be included in this section. In step 2600 of the method, the host computer provides user data. In an optional sub-step (not shown) the host computer provides the user data by executing a host application. In step 2602, the host computer initiates a transmission carrying the user data to the UE. The transmission may pass via the base station, in accordance with the teachings of the embodiments described throughout this disclosure. In step 2604 (which may be optional), the UE receives the user data carried in the transmission.

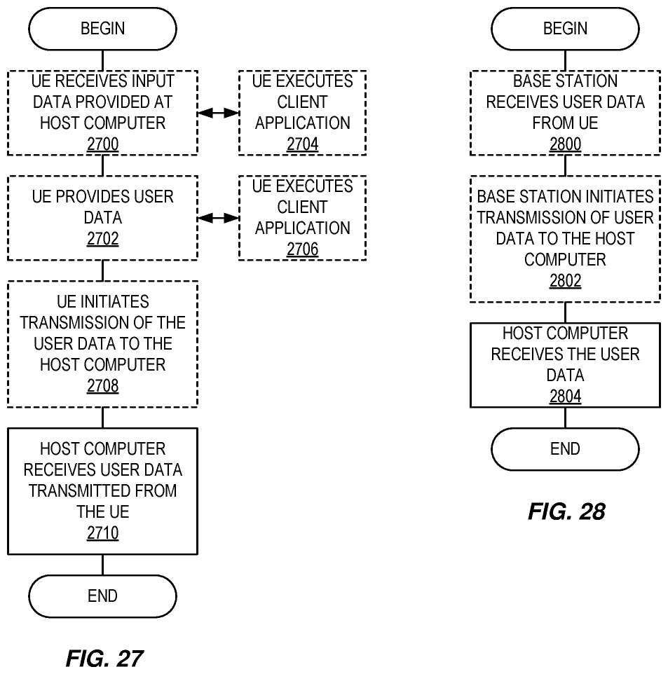

FIG. 27 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 27 will be included in this section. In step 2700 (which may be optional), the UE receives input data provided by the host computer. Additionally or alternatively, in step 2702, the UE provides user data. In sub-step 2704 (which may be optional) of step 2700, the UE provides the user data by executing a client application. In sub-step 2706 (which may be optional) of step 2702, the UE executes a client application which provides the user data in reaction to the received input data provided by the host computer. In providing the user data, the executed client application may further consider user input received from the user. Regardless of the specific manner in which the user data was provided, the UE initiates, in sub-step 2708 (which may be optional), transmission of the user data to the host computer. In step 2710 of the method, the host computer receives the user data transmitted from the UE, in accordance with the teachings of the embodiments described throughout this disclosure.

FIG. 28 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 28 will be included in this section. In step 2800 (which may be optional), in accordance with the teachings of the embodiments described throughout this disclosure, the base station receives user data from the UE. In step 2802 (which may be optional), the base station initiates transmission of the received user data to the host computer. In step 2804 (which may be optional), the host computer receives the user data carried in the transmission initiated by the base station.

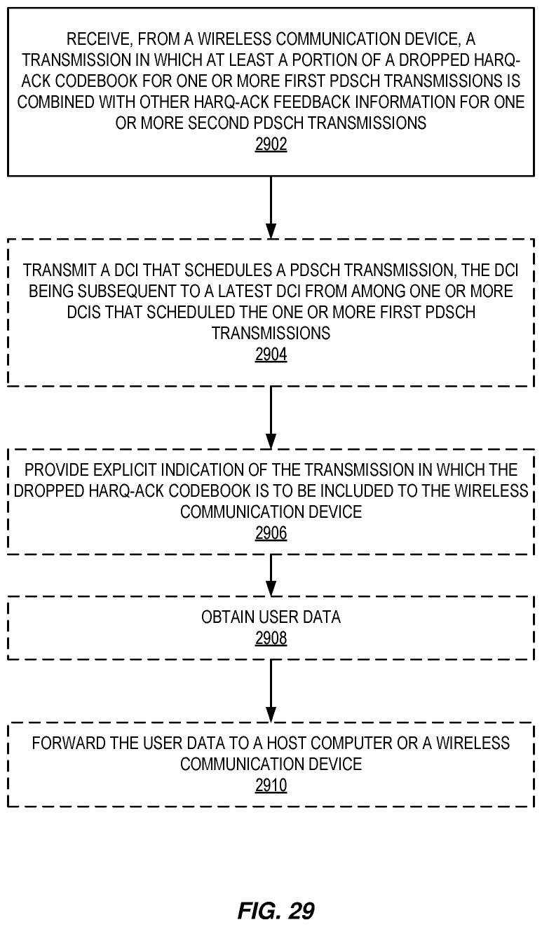

FIG. 29 is a flowchart illustrating a method performed by a base station for obtaining HARQ feedback. Optional features are represented by dashed boxes. The base station may be, for example, a base station 2300 or non-terrestrial radio access node that operates in accordance with any of the embodiments described herein.

At step 2902, the base station receives, from a wireless communication device (e.g., wireless communication device 812 of FIG. 8), a transmission in which at least a portion of a dropped HARQ-ACK codebook for one or more first PDSCH transmissions is combined with other HARQ-ACK feedback information for one or more second PDSCH transmissions. In some embodiments, the dropped HARQ-ACK codebook was dropped due to a higher priority transmission.

In some embodiments, receiving the transmission at step 2902 includes receiving at least a portion of the dropped HARQ-ACK codebook in the transmission as if each K1 value associated to each bit in the dropped HARQ-ACK codebook is a non-numerical value, irrespective of actual K1 values associated to the bits in the dropped HARQ-ACK codebook.

In some embodiments, the received transmission is an immediate next PUCCH or PUSCH transmission that includes HARQ-ACK feedback information (e.g., low priority HARQ-ACK feedback information) following the dropping of the HARQ-ACK codebook. Alternatively, in some embodiments, the transmission is an earliest PUCCH or PUSCH transmission that includes HARQ-ACK feedback information (e.g., low priority HARQ-ACK feedback information) following a certain required time gap after the HARQ-ACK codebook was dropped.

In some embodiments, the transmission is a transmission due to which the dropped HARQ-ACK codebook was dropped (e.g., a higher priority transmission). Alternatively, or additionally, in some embodiments the transmission is determined based on one or more rules. Alternatively, or additionally, in some embodiments the transmission is determined based on PDSCH grouping in enhanced dynamic codebook.

At step 2904, optionally, the base station transmits a DCI that schedules a PDSCH transmission, the DCI being subsequent to a latest DCI from among one or more DCIs that scheduled the one or more first PDSCH transmissions. In some embodiments, receiving the transmission at step 2902 includes receiving a PUCCH or PUSCH transmission that includes at least a portion of the dropped HARQ-ACK codebook combined with other HARQ-ACK feedback information for the PDSCH transmission scheduled by the DCI.

At step 2906, optionally, the base station provides, to the wireless communication device (e.g., WCD 812), an explicit indication of the transmission in which the dropped HARQ-ACK codebook is to be included.

At step 2908, optionally, the base station obtains user data. At step 2910, optionally, the base station forwards the user data to a host computer or a wireless communication device.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Group A Embodiments

Embodiment 1: a method performed by a wireless communication device for providing HARQ feedback. The method includes dropping a first transmission that was to comprise a HARQ-ACK codebook that comprises HARQ-ACK feedback information for one or more first PDSCH transmissions. The method includes transmitting a second transmission in which the at least a portion of the dropped HARQ-ACK codebook is combined with other HARQ-ACK feedback information for one or more second PDSCH transmissions.

Embodiment 2: the method of embodiment 1, wherein dropping the first transmission comprises dropping the first transmission due to an overlap with a higher priority transmission within a time domain

Embodiment 3: the method of embodiment 1 wherein dropping the first transmission comprises dropping the first transmission due to an overlap with a transmission that includes higher priority HARQ-ACK feedback information within a time domain

Embodiment 4: the method of any of embodiments 1 to 3 wherein transmitting the second transmission includes detecting a DCI that schedules a PDSCH transmission, the DCI being detected subsequent to a latest DCI from among one or more DCIs that scheduled the one or more first PDSCH transmissions and transmitting a PUCCH or PUSCH transmission that includes at least a portion of the dropped HARQ-ACK codebook combined with other HARQ-ACK feedback information for the PDSCH transmission scheduled by the DCI.

Embodiment 4A: The method of embodiment 4, wherein detecting the DCI that schedules the PDSCH transmission comprises detecting that the DCI comprises an indication that a UE should include previously dropped HARQ-ACK data in a HARQ-ACK codebook

Embodiment 5: the method of any of embodiments 1 to 3 wherein transmitting the second transmission includes transmitting the at least a portion of the dropped HARQ-ACK codebook in the second transmission as if each K1 value associated to each bit in the dropped HARQ-ACK codebook is a non-numerical value, irrespective of actual K1 values associated to the bits in the dropped HARQ-ACK codebook.

Embodiment 6: the method of any of embodiments 1 to 3 wherein transmitting the second transmission includes including the at least a portion of the dropped HARQ-ACK codebook in the second transmission responsive to a counter DAI based determination.

Embodiment 7: the method of any of embodiments 1 to 3 wherein the second transmission is an immediate next PUCCH or PUSCH transmission that comprises HARQ-ACK feedback information (e.g., low priority HARQ-ACK feedback information).

Embodiment 8: the method of any of embodiments 1 to 3 wherein the second transmission is an earliest PUCCH or PUSCH transmission that includes HARQ-ACK feedback information (e.g., low priority HARQ-ACK feedback information) following a certain required time gap.

Embodiment 9: the method of any of embodiments 1 to 3 wherein the second transmission in which the dropped HARQ-ACK codebook is to be included is explicitly indicated to the wireless communication device (812) (e.g., from an associated base station).

Embodiment 10: the method of any of embodiments 1 to 3 wherein the second transmission is a transmission due to which the first transmission was dropped (e.g., a higher priority transmission).

Embodiment 11: the method of any of embodiments 1 to 3 wherein the second transmission is determined based on one or more rules.

Embodiment 12: the method of any of embodiments 1 to 3 wherein the second transmission is determined based on PDSCH grouping in enhanced dynamic codebook.

Embodiment 13: the method of any of embodiments 1-12, further including providing user data and forwarding the user data to a host computer via the transmission to the base station.

### Group B Embodiments

Embodiment 14: a method performed by a base station for obtaining HARQ feedback. The method includes receiving, from a wireless communication device, a transmission in which at least a portion of a dropped HARQ-ACK codebook for one or more first PDSCH transmissions is combined with other HARQ-ACK feedback information for one or more second PDSCH transmissions.

Embodiment 15: the method of embodiment 14, wherein the dropped HARQ-ACK codebook was dropped due to a higher priority transmission.

Embodiment 16: the method of embodiment 14 or 15 wherein receiving the transmission comprises receiving the at least a portion of the dropped HARQ-ACK codebook in the transmission as if each K1 value associated to each bit in the dropped HARQ-ACK codebook is a non-numerical value, irrespective of actual K1 values associated to the bits in the dropped HARQ-ACK codebook.

Embodiment 17: the method of embodiment 14 or 15 further including transmitting a DCI that schedules a PDSCH transmission, the DCI being subsequent to a latest DCI from among one or more DCIs that scheduled the one or more first PDSCH transmissions. Receiving the transmission includes receiving a PUCCH or PUSCH transmission that includes at least a portion of the dropped HARQ-ACK codebook combined with other HARQ-ACK feedback information for the PDSCH transmission scheduled by the DCI.

Embodiment 18: the method of embodiment 14 or 15 wherein the transmission is an immediate next PUCCH or PUSCH transmission that comprises HARQ-ACK feedback information (e.g., low priority HARQ-ACK feedback information) following the dropping of the HARQ-ACK codebook.

Embodiment 19: the method of embodiment 14 or 15 wherein the transmission is an earliest PUCCH or PUSCH transmission that includes HARQ-ACK feedback information (e.g., low priority HARQ-ACK feedback information) following a certain required time gap after the HARQ-ACK codebook was dropped.

Embodiment 20: the method of embodiment 14 or 15 further including providing, to the wireless communication device, an explicit indication of the transmission in which the dropped HARQ-ACK codebook is to be included.

Embodiment 21: the method of embodiment 14 or 15 wherein the transmission is a transmission due to which the dropped HARQ-ACK codebook was dropped (e.g., a higher priority transmission).

Embodiment 22: the method of embodiment 14 or 15 wherein the transmission is determined based on one or more rules.

Embodiment 23: the method of embodiment 14 or 15 wherein the transmission is determined based on PDSCH grouping in enhanced dynamic codebook.

### Group C Embodiments

Embodiment 24: the method of any of embodiments 14-23, further including obtaining user data and forwarding the user data to a host computer or a wireless

Embodiment 25: a wireless communication device comprising processing circuitry configured to perform any of the steps of any of the Group A embodiments and power supply circuitry configured to supply power to the wireless communication device.

Embodiment 26: a base station comprising processing circuitry configured to perform any of the steps of any of the Group B embodiments and power supply circuitry configured to supply power to the base station.

Embodiment 27: a UE including an antenna configured to send and receive wireless signals, radio front-end circuitry connected to the antenna and to processing circuitry and configured to condition signals communicated between the antenna and the processing circuitry. The processing circuitry is configured to perform any of the steps of any of the Group A embodiments. An input interface is connected to the processing circuitry and is configured to allow input of information into the UE to be processed by the processing circuitry. An output interface is connected to the processing circuitry and configured to output information from the UE that has been processed by the processing circuitry. A battery is connected to the processing circuitry and configured to supply power to the UE.

Embodiment 28: a communication system including a host computer comprising processing circuitry configured to provide user data and a communication interface configured to forward the user data to a cellular network for transmission to a UE. The cellular network includes a base station having a radio interface and processing circuitry, the base station's processing circuitry configured to perform any of the steps of any of the Group B embodiments.

Embodiment 29: the communication system of the previous embodiment further including the base station.

Embodiment 30: the communication system of the previous 2 embodiments, further including the UE, wherein the UE is configured to communicate with the base station.

Embodiment 31: the communication system of the previous 3 embodiments, wherein the processing circuitry of the host computer is configured to execute a host application, thereby providing the user data, and the UE includes processing circuitry configured to execute a client application associated with the host application.

Embodiment 32: a method implemented in a communication system including a host computer, a base station, and a User Equipment (UE) the method including, at the host computer, providing user data, and at the host computer, initiating a transmission carrying the user data to the UE via a cellular network including the base station, wherein the base station performs any of the steps of any of the Group B embodiments.

Embodiment 33: the method of the previous embodiment, further including, at the base station, transmitting the user data.

Embodiment 34: the method of the previous 2 embodiments, wherein the user data is provided at the host computer by executing a host application, the method further including, at the UE, executing a client application associated with the host application.

Embodiment 35: a UE configured to communicate with a base station, the UE including a radio interface and processing circuitry configured to perform the method of the previous 3 embodiments.

Embodiment 36: a communication system including a host computer comprising processing circuitry configured to provide user data, and a communication interface configured to forward user data to a cellular network for transmission to a UE, wherein the UE comprises a radio interface and processing circuitry, the UE's components configured to perform any of the steps of any of the Group A embodiments.

Embodiment 37: the communication system of the previous embodiment, wherein the cellular network further includes a base station configured to communicate with the UE.

Embodiment 38: the communication system of the previous 2 embodiments, wherein the processing circuitry of the host computer is configured to execute a host application, thereby providing the user data and the UE's processing circuitry is configured to execute a client application associated with the host application.

Embodiment 39: a method implemented in a communication system including a host computer, a base station, and a UE, the method including, at the host computer, providing user data, and at the host computer, initiating a transmission carrying the user data to the UE via a cellular network comprising the base station, wherein the UE performs any of the steps of any of the Group A embodiments.

Embodiment 40: the method of the previous embodiment, further including at the UE, receiving the user data from the base station.

Embodiment 41: a communication system including a host computer comprising a communication interface configured to receive user data originating from a transmission from a UE to a base station wherein the UE includes a radio interface and processing circuitry, the UE's processing circuitry configured to perform any of the steps of any of the Group A embodiments.

Embodiment 42: the communication system of the previous embodiment, further including the UE.

Embodiment 43: the communication system of the previous 2 embodiments, further including the base station, wherein the base station comprises a radio interface configured to communicate with the UE and a communication interface configured to forward to the host computer the user data carried by a transmission from the UE to the base station.

Embodiment 44: the communication system of the previous 3 embodiments, wherein the processing circuitry of the host computer is configured to execute a host application, and the UE's processing circuitry is configured to execute a client application associated with the host application, thereby providing the user data.

Embodiment 45: the communication system of the previous 4 embodiments, wherein the processing circuitry of the host computer is configured to execute a host application, thereby providing request data and the UE's processing circuitry is configured to execute a client application associated with the host application, thereby providing the user data in response to the request data.

Embodiment 46: a method implemented in a communication system including a host computer, a base station, and a UE, the method including, at the host computer, receiving user data transmitted to the base station from the UE, wherein the UE performs any of the steps of any of the Group A embodiments.

Embodiment 47: the method of the previous embodiment, further including, at the UE, providing the user data to the base station.

Embodiment 48: the method of the previous 2 embodiments, further comprising, at the UE, executing a client application, thereby providing the user data to be transmitted, and at the host computer, executing a host application associated with the client application.

Embodiment 49: the method of the previous 3 embodiments, further including, at the UE, executing a client application, and at the UE, receiving input data to the client application, the input data being provided at the host computer by executing a host application associated with the client application, wherein the user data to be transmitted is provided by the client application in response to the input data.

Embodiment 50: a communication system including a host computer including a communication interface configured to receive user data originating from a transmission from a UE to a base station, wherein the base station includes a radio interface and processing circuitry, the base station's processing circuitry configured to perform any of the steps of any of the Group B embodiments.

Embodiment 51: the communication system of the previous embodiment further including the base station.

Embodiment 52: the communication system of the previous 2 embodiments, further including the UE, wherein the UE is configured to communicate with the base station.

Embodiment 53: the communication system of the previous 3 embodiments, wherein the processing circuitry of the host computer is configured to execute a host application and the UE is configured to execute a client application associated with the host application, thereby providing the user data to be received by the host computer.

Embodiment 54: a method implemented in a communication system including a host computer, a base station, and a UE, the method including, at the host computer, receiving, from the base station, user data originating from a transmission which the base station has received from the UE, wherein the UE performs any of the steps of any of the Group A embodiments.

Embodiment 55: the method of the previous embodiment, further including, at the base station, receiving the user data from the UE.

Embodiment 56: the method of the previous 2 embodiments, further including, at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device for providing Hybrid Automatic Repeat Request (HARQ) feedback, the method comprising:
dropping a first transmission that was to comprise a HARQ-Acknowledgement (ARQ-ACK) codebook that comprises HARQ-ACK feedback information for one or more first Physical Downlink Shared Channel (PDSCH) transmissions; and
transmitting a second transmission in which at least a portion of the HARQ-ACK codebook is combined with other HARQ-ACK feedback information for one or more second PDSCH transmissions.

2. The method of claim 1, wherein dropping the first transmission comprises dropping the first transmission due to an overlap with a higher priority transmission within a time domain.

3. The method of claim 1, wherein dropping the first transmission comprises dropping the first transmission due to an overlap with a transmission that comprises higher priority HARQ-ACK feedback information within a time domain.

4. The method of claim 1, wherein transmitting the second transmission comprises:
detecting a Downlink Control Information (DCI) that schedules a PDSCH transmission, the DCI being detected subsequent to a latest DCI from among one or more DCIs that scheduled the one or more first PDSCH transmissions; and
transmitting a Physical Uplink Control Channel (PUCCH) or Physical Uplink Shared Channel transmission that comprises at least a portion of the HARQ-ACK codebook combined with other HARQ-ACK feedback information for the PDSCH transmission scheduled by the DCI.

5. The method of claim 4, wherein detecting the DCI that schedules the PDSCH transmission comprises detecting that the DCI comprises an indication that a UE should include previously dropped HARQ-ACK data in a HARQ-ACK codebook.

6. The method of claim 1, wherein transmitting the second transmission comprises transmitting the at least a portion of the HARQ-ACK codebook in the second transmission as if each K1 value associated to each bit in the dropped HARQ-ACK codebook is a non-numerical value, irrespective of actual K1 values associated to the bits in the dropped HARQ-ACK codebook.

7. The method of claim 1, wherein transmitting the second transmission comprises including the at least a portion of the HARQ-ACK codebook in the second transmission responsive to a counter Downlink Assignment Indicator (DAI) based determination.

8. The method of claim 1, wherein the second transmission is an immediate next Physical Uplink Control Channel (PUCCH) or Physical Uplink Shared Channel transmission that comprises HARQ-ACK feedback information.

9. The method of claim 1, wherein the second transmission is an earliest Physical Uplink Control Channel (PUCCH) or Physical Uplink Shared Channel transmission that comprises HARQ-ACK feedback information following a certain required time gap.

10. The method of claim 1, wherein the second transmission in which the dropped HARQ-ACK codebook is to be included is explicitly indicated to the wireless communication device.

11. The method of claim 1, wherein the second transmission is a higher priority transmission than the first transmission that was dropped.

12. The method of claim 1, wherein:
the second transmission corresponds to a PUCCH with a priority higher than a priority of the first transmission; and
the first transmission is dropped based at least in part on the priority of the PUCCH and the priority of the first transmission.

13. The method of claim 1, wherein the second transmission is determined based on PDSCH grouping in an enhanced dynamic codebook.

14. (canceled)

15. (canceled)

16. A wireless communication device for providing Hybrid Automatic Repeat Request (HARQ) feedback, the wireless communication device comprising:
one or more transmitters;
one or more receivers; and
processing circuitry associated with the one or more transmitters and the one or more receivers, the processing circuitry configured to cause the wireless communication device to:
drop a first transmission that was to comprise a HARQ-Acknowledgement (HARQ-ACK) codebook that comprises HARQ-ACK feedback information for one or more first Physical Downlink Shared Channel (PDSCH) transmissions; and
transmit a second transmission in which at least a portion of the HARQ-ACK codebook is combined with other HARQ-ACK feedback information for one or more second PDSCH transmissions.

17. (canceled)

18. A method performed by a base station for obtaining Hybrid Automatic Repeat Request (HARQ) feedback, the method comprising:
receiving, from a wireless communication device, a transmission in which at least a portion of a dropped HARQ-Acknowledgement HARQ-ACK) codebook for one or more first Physical Downlink Shared Channel (PDSCH) transmissions is combined with other HARQ-ACK feedback information for one or more second PDSCH transmissions.

19. The method of claim 18, wherein the dropped HARQ-ACK codebook was dropped due to overlap with a higher priority transmission within a time domain.

20. The method of claim 18, wherein receiving the transmission comprises receiving the at least a portion of the dropped HARQ-ACK codebook in the transmission as if each K1 value associated to each bit in the dropped HARQ-ACK codebook is a non-numerical value, irrespective of actual K1 values associated to the bits in the dropped HARQ-ACK codebook.

21. The method of claim 18, wherein the method further comprises:
transmitting a Downlink Control Information (DCI) that schedules a PDSCH transmission, the DCI being subsequent to a latest DCI from among one or more DCIs that scheduled the one or more first PDSCH transmissions; and
wherein receiving the transmission comprises receiving a Physical Uplink Control Channel or Physical Uplink Shared Channel (PUSCH) transmission that comprises at least a portion of the dropped HARQ-ACK codebook combined with other HARQ-ACK feedback information for the PDSCH transmission scheduled by the DCI.

22. The method of claim 18, wherein the transmission is an immediate next Physical Uplink Control Channel (PUCCH) or Physical Uplink Shared Channel (PUSCH) transmission that comprises HARQ-ACK feedback information following the dropping of the HARQ-ACK codebook.

23. The method of claim 18, wherein the transmission is an earliest Physical Uplink Control Channel, PUCCH, or Physical Uplink Shared Channel (PUSCH) transmission that comprises HARQ-ACK feedback information following a certain required time gap after the HARQ-ACK codebook was dropped.

24. The method of claim 18, further comprising providing, to the wireless communication device, an explicit indication of the transmission in which the dropped HARQ-ACK codebook is to be included.

25. The method of claim 18 wherein the transmission is a transmission due to which the dropped HARQ-ACK codebook was dropped.

26. The method of claim 18 wherein the transmission is determined based on one or more rules.

27. The method of claim 18 wherein the transmission is determined based on PDSCH grouping in enhanced dynamic codebook.

28. (canceled)

29. (canceled)

30. A base station for obtaining Hybrid Automatic Repeat Request (HARQ) feedback, the base station comprising:
processing circuitry configured to cause the base station to:
receive, from a wireless communication device, a transmission in which at least a portion of a dropped HARQ-Acknowledgement (HARQ-ACK) codebook for one or more first Physical Downlink Shared Channel transmissions is combined with other HARQ-ACK feedback information for one or more second PDSCH transmissions.

31. (canceled)

32. The wireless device of claim 16, wherein dropping the first transmission comprises dropping the first transmission due to an overlap with a higher priority transmission within a time domain.

33. The wireless device of claim 16, wherein dropping the first transmission comprises dropping the first transmission due to an overlap with a transmission that comprises higher priority HARQ-ACK feedback information within a time domain.
